(19) United States
(12) Patent Application Publication
(10) Pub. No.: US 2013/0155204 A1
(43) Pub. Date: Jun. 20, 2013

(54) IMAGING APPARATUS AND MOVEMENT CONTROLLING METHOD THEREOF

(71) Applicant: FUJIFILM Corporation, Tokyo (JP)

(72) Inventors: Hideaki KOKUBUN, Saitama (JP); Hihashi ENDO, Saitama (JP)

(73) Assignee: FUJIFILM Corporation, Tokyo (JP)

(21) Appl. No.: 13/765,430

(22) Filed: Feb. 12, 2013

Related U.S. Application Data
(63) Continuation-in-part of application No. PCT/JP2011/063799, filed on Jun. 16, 2011.

(30) Foreign Application Priority Data
Aug. 24, 2010 (JP) 2010-187316
Feb. 2, 2011 (JP) 2011-020549

(51) Int. Cl. H04N 13/02

(52) U.S. Cl. CPC H04N 13/0203
USPC 348/49

(57) ABSTRACT

A left-eye image and a right-eye image for a stereoscopic image are obtained using a camera including a single imaging apparatus. The left-eye image is obtained by imaging objects OB10, OB20, and OB30 at a reference position PL11 using a digital still camera 1. A necessary parallax amount which decreases as the inter-object distance between the object OB10 closest to the camera 1 and the object OB30 farthest from the camera 1 is long, and increases as the inter-object distance is short is decided. The digital still camera 1 moves in a right direction while continuously imaging the objects OB10, OB20, and OB30. If the digital still camera 1 is moved by the decided parallax amount, and a subject image having the decided parallax amount is obtained, the subject image is automatically recorded as the right-eye image.

### BACKGROUND OF THE INVENTION

1. Field of the Invention

The present invention relates to an imaging apparatus and a movement controlling method.

2. Description of the Related Art

In order to obtain a left-eye image (an image which is viewed by a viewer with a left eye) and a right-eye image (an image which is viewed by the viewer with a right eye) for displaying a stereoscopic image using a digital still camera with a single imaging apparatus instead of a digital still camera for stereoscopic imaging, the camera is deviated in a horizontal direction by a parallax amount between the left-eye image and the right-eye image, and performs imaging twice. A stereoscopic imaging apparatus which extracts images with parallax from images imaged in advance is known (JP2009-3609A). A stereoscopic imaging apparatus in which controls a positional difference between a plurality of photographing positions based on the depth of a subject is also known (JP2003-140279A).

### SUMMARY OF THE INVENTION

However, according to the invention disclosed in JP2009-3609A, there are few images having an appropriate parallax amount. Moreover, according to the invention disclosed in JP2003-140279A, while a plurality of photographing positions are controlled, the control will becomes cumbersome and complicated.

Therefore, an object of the present invention is to obtain image data for a stereoscopic image more easily.

An imaging apparatus (stereoscopic imaging apparatus) according to an aspect of the present invention includes an imaging unit which continuously images a subject in an imaging range and continuously outputs imaged image data, a first recording control unit which, if a recording instruction is given, records image data imaged at the timing, at which the recording instruction is given, in a recording medium as image data representing a first subject image, an object detection unit which detects all objects satisfying a predetermined condition from subject images for object detection among subject images represented by image data continuously output from the imaging unit, a first distance information calculation unit which calculates distance information between an object closest to the imaging apparatus and an object farthest from the object detection unit among a plurality of objects, a parallax amount decision unit which decides a parallax amount based on the distance information calculated by the first distance information calculation unit, and a second recording control unit which, when the imaging apparatus is deviated in a horizontal direction to make the amount of deviation between a subject image represented by image data continuously output from the imaging unit and the first subject image in the horizontal direction equal to the parallax amount decided by the parallax amount decision unit (including not only when both are perfectly equal but also when it is considered that both are substantially equal), records image data imaged at this timing as image data representing a second subject image in the recording medium in association with image data representing the first subject image.

Another aspect of the present invention provides a movement controlling method for an imaging apparatus. That is, in this method, an imaging unit continuously images a subject in an imaging range and continuously outputs imaged image data, if a recording instruction is given, a first recording control unit records image data imaged at the timing, at which the recording instruction is given, in a recording medium as image data representing a first subject image, an object detection unit detects all objects satisfying a predetermined condition from subject images for object detection among subject images represented by image data continuously output from the imaging unit, a first distance information calculation unit calculates distance information between an object closest to the imaging apparatus and an object farthest from the object detection unit among a plurality of objects, a parallax amount decision unit decides a parallax amount based on the distance information calculated by the first distance information calculation unit, and when the imaging apparatus is deviated in a horizontal direction to make the amount of deviation between a subject image represented by image data continuously output from the imaging unit and the first subject image in the horizontal direction equal to the parallax amount decided by the parallax amount decision unit, a second recording control unit records image data imaged at this timing as image data representing a second subject image in the recording medium in association with image data representing the first subject image.

According to the aspects of the present invention, the subject in the imaging range is continuously imaged. If the recording instruction is given, image data imaged at this timing is recorded in the recording medium (including a recording medium which is removable from the imaging apparatus, and a recording medium which is embedded in the imaging apparatus) as image data representing the first subject image. All objects (for example, a face of a character or an object having a spatial frequency equal to or greater than a predetermined threshold value) satisfying a predetermined condition are detected from any subject image for object detection among the subject images obtained by continuously imaging the subject. The distance information between the object closest to the imaging apparatus and the object farthest from the imaging apparatus among a plurality of detected objects is calculated. parallax amount (a parallax amount for allowing the first subject image to be viewed as a stereoscopic image) is decided based on the calculated distance information. If the imaging apparatus is moved by the user, and the parallax amount between the imaged subject image and the first subject image becomes equal to the decided parallax amount, image data imaged at the timing at which the parallax amount becomes equal is recorded in the recording medium as image data representing the second subject image in association with image data representing the first subject image. The stereoscopic image is obtained using the first subject image and the second subject image.

The imaging apparatus may further include a second distance information calculation unit which measures distance information from the imaging apparatus to each of a plurality of objects in the imaging range. In this case, for example, the first distance information calculation unit calculates the distance information between the closest object and the farthest object from the distance information to the closest object and the distance information to the farthest object calculated by the second distance information calculation unit.

The imaging unit may include an imaging element and a focus lens. In this case, the imaging apparatus further includes an AF evaluation value calculation unit which calculates an AF evaluation value representing the degree of focusing at each movement position from image data imaged at each movement position while moving the focus lens. The second distance information calculation unit measures the distance to each of the plurality of objects based on the position of the focus lens when the AF evaluation value calculated by the AF evaluation value calculation unit becomes equal to or greater than a threshold value. The focus lens freely moves the front side of the imaging element, that is, the subject side with respect to the imaging element.

For example, the parallax amount decision unit decides the parallax amount defined in advance when the second distance information calculation unit is able to measure only the distance to one object among a plurality of objects detected by the object detection unit.

The parallax amount decision unit decides the parallax amount based on the size of a display screen on which a stereoscopic image is displayed and the distance information calculated by the first distance information calculation unit.

The imaging apparatus may further include a setting unit which sets the size of a display screen on which a stereoscopic image is displayed. In this case, the parallax amount decision unit decides the parallax amount based on the size of the display screen set by the setting unit and the distance information calculated by the first distance information calculation unit. For example, the second recording control unit repeats processing for, when the imaging apparatus is deviated in the horizontal direction to make the amount of deviation between the subject image represented by image data continuously output from the imaging unit and the first subject image in the horizontal direction equal to any parallax amount of a plurality of parallax amounts decided by the parallax amount decision unit, recording image data imaged at this timing as image data representing the second subject image in the recording medium in association with image data representing the first subject image for the plurality of parallax amounts.

The imaging apparatus may further include a reading unit which reads image data representing the first subject image stored in the recording medium and image data representing the second subject image recorded in the recording medium from the recording medium in response to a stereoscopic reproduction instruction, and a display control unit which performs control such that a display device displays a first subject image represented by image data representing the first subject image and a second subject image represented by image data representing the second subject image read by the reading unit with deviation in the horizontal direction by the parallax amount decided by the parallax amount decision unit.

The imaging apparatus may further include an object type decision unit which decides the type of an object in the subject images for object detection. In this case, for example, the object type decision unit detects an object of a type defined in advance among the types of objects decided by the object type decision unit. For example, the object detection unit detects an object of a type excluding a type defined in advance among the types of objects decided by the object type decision unit.

The imaging apparatus may further include a distance calculation unit which calculates the distance to an object whose type is decided by the object decision unit. In this case, for example, the object detection unit detects an object excluding an object, whose distance calculated by the distance calculation unit is equal to or smaller than a first threshold value, and an object, whose distance is equal to or greater than a second threshold value greater than the first threshold value, among the objects of the types decided by the object type decision unit.

Preferably, the imaging apparatus further includes a display device which displays the first subject image on a display screen, and a touch panel which is formed in the display screen. In this case, for example, the object detection unit detects an object displayed at a position where the touch panel is touched.

### BRIEF DESCRIPTION OF THE DRAWINGS

FIG. 1 shows the relationship between a digital still camera and a subject.

FIG. 2 shows a display screen size setting image.

FIG. 3 is a flowchart showing a processing procedure in a stereoscopic imaging mode.

FIG. 4 is a flowchart showing a processing procedure in a stereoscopic imaging mode.

FIG. 5 shows the relationship between a focus lens position and an AF evaluation value.

FIG. 6 shows the relationship between a subject distance and a necessary parallax amount.

FIG. 7 shows the relationship between a subject distance and a necessary parallax amount.

FIG. 8 shows the relationship between a display screen size and a necessary parallax amount.

FIG. 9 shows the relationship between a subject, a display screen size, and a necessary parallax amount.

FIG. 10 is a flowchart showing a processing procedure in a stereoscopic imaging mode.

FIG. 11 shows the relationship between a focus lens position and an AF evaluation value.

FIG. 12 is a flowchart showing a processing procedure in a stereoscopic imaging mode.

FIG. 13 shows the distance to a subject.

FIG. 14 shows an example of a subject image which is displayed on a display screen.

FIG. 15 shows a rear surface of a digital still camera.

FIG. 16 shows the relationship between an imaging position and a subject.

FIG. 17A shows an example of a left-eye image, and

FIG. 17B shows an example of a right-eye image.

FIG. 18 shows an example of a stereoscopic image.

FIG. 19 shows the relationship between a parallax amount and a subject distance.

FIG. 20 is a flowchart showing a necessary parallax amount calculation processing procedure.

FIG. 21 shows an example of a file structure.

FIG. 22 is a block diagram showing an electrical configuration of a digital still camera.

FIG. 23 shows the relationship between a digital still camera and a subject.

FIG. 24 shows the relationship between a parallax amount and an inter-object distance.

FIG. 25 shows the relationship between a parallax amount and an inter-object distance.

FIG. 26 is a flowchart showing a necessary parallax amount calculation processing procedure.

FIG. 27 shows an example of a file structure.

FIG. 28A shows an example of a left-eye image, and

FIG. 28B shows an example of a right-eye image.

FIG. 29 shows an example of a stereoscopic image.

FIG. 30 is a block diagram showing an electrical configuration of a digital still camera.

FIG. 31 is a flowchart showing an object type decision processing procedure.

FIG. 32 shows an example of a subject image for object detection.

FIG. 33 shows an example of a subject image for object detection in which regions are divided by object.

FIG. 34 is a flowchart showing an object detection processing procedure.

FIG. 35 is a flowchart showing an object detection processing procedure.

FIG. 36 is a flowchart showing an object detection processing procedure.

FIG. 37 shows the relationship between an AF evaluation value and a focus lens position.

FIG. 38 shows the relationship between an AF evaluation value and a focus lens position.

FIG. 39 is a flowchart showing an object detection processing procedure.

FIG. 40 shows a subject image for object detection.

### DESCRIPTION OF THE PREFERRED EMBODIMENTS

In order to display a stereoscopic image, a left-eye image which is viewed by a viewer with a left eye and a right-eye image which is viewed by the viewer with a right eye are required. In a digital still camera for imaging a stereoscopic image, two imaging apparatuses are provided, the left-eye image is imaged using one imaging apparatus, and the right-eye image is imaged using the other imaging apparatus. In this example, a left-eye image and a right-eye image for displaying a stereoscopic image are obtained using a digital still camera with a single imaging apparatus, instead of the digital still camera for imaging a stereoscopic image with two imaging apparatuses.

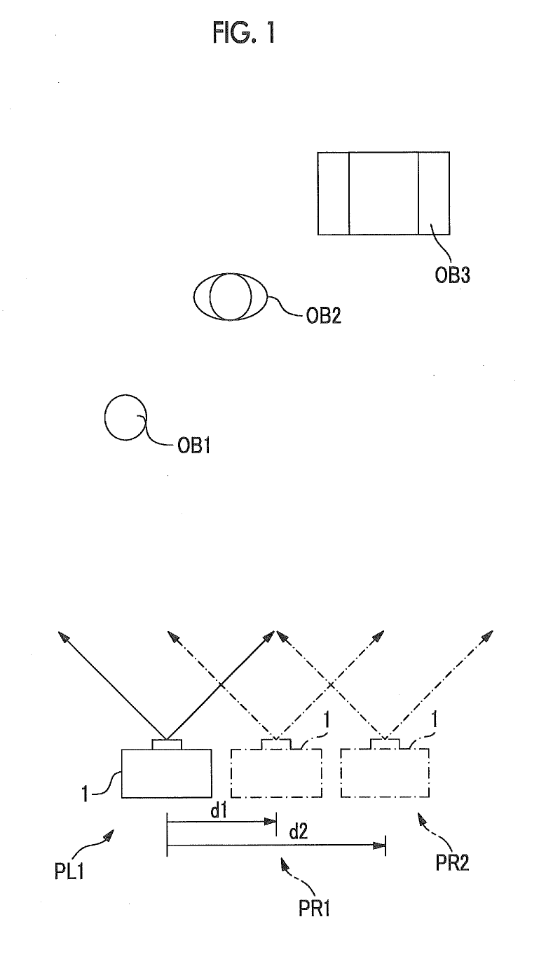

FIGS. 1 to 22 show a first example.

FIG. 1 shows the relationship between a digital still camera 1 including a single imaging apparatus and a subject in plan view.

There are a tree subject OB1, a character subject OB2, and an automobile subject OB3 in front of the digital still camera 1. The tree subject OB1 is closest to the digital still camera 1, and the character subject OB2 is second closest to the digital still camera 1. The automobile subject OB3 is farthest from the digital still camera 1.

First, the digital still camera 1 is positioned at a reference position PL1 and the subjects OB1, OB2, and OB3 are imaged, and image data representing the subject images of the subjects OB1, OB2, and OB3 is recorded. The subject images imaged at the reference position PL1 becomes left-eye images (may become right-eye images).

As described below, for example, a parallax amount dl suitable for displaying a stereoscopic image on a 3-inch display screen and a parallax amount d2 suitable for displaying a stereoscopic image on a 32-inch display screen are calculated.

The user moves the digital still camera 1 in a right direction while continuously (periodically) imaging the subjects OB1, OB2, and OB3. While the digital still camera 1 is moving in the right direction, the subjects OB1, OB2, and OB3 are imaged. When the digital still camera 1 is at a position PRI, if the parallax of the imaged subject images becomes the calculated parallax amount d1, the imaged subject images become right-eye images which are displayed on the 3-inch display screen, and are recorded as image data representing the right-eye images. When the user moves the digital still camera 1 in the right direction, and the digital still camera 1 is at a position PR2, if the parallax of the imaged subject images becomes the calculated parallax amount d2, the imaged subject images become right-eye images which are displayed on the 32-inch display screen, and are recorded as image data representing the right-eye images.

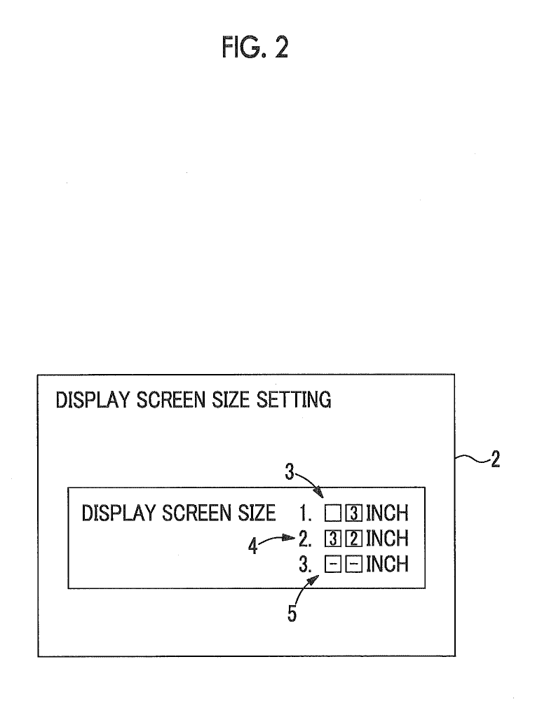

FIG. 2 is an example of a display screen size setting image.

The display screen size setting image is used to set the size of a display screen on which a stereoscopic image is displayed. Image data representing the left-eye images and image data representing the right-eye images having a parallax amount corresponding to the size of a display screen set using the display screen size setting image are recorded.

A setting mode is set by a mode setting button in the digital still camera 1. If a display screen size setting mode in the setting mode is set, the display screen size setting image is displayed on a display screen 2 formed in the rear surface of the digital still camera 1.

In the display screen size setting image, display screen size input regions 3, 4, and 5 are formed. The size of a display screen is input to the input regions 3, 4, and 5 using buttons in the digital still camera 1.

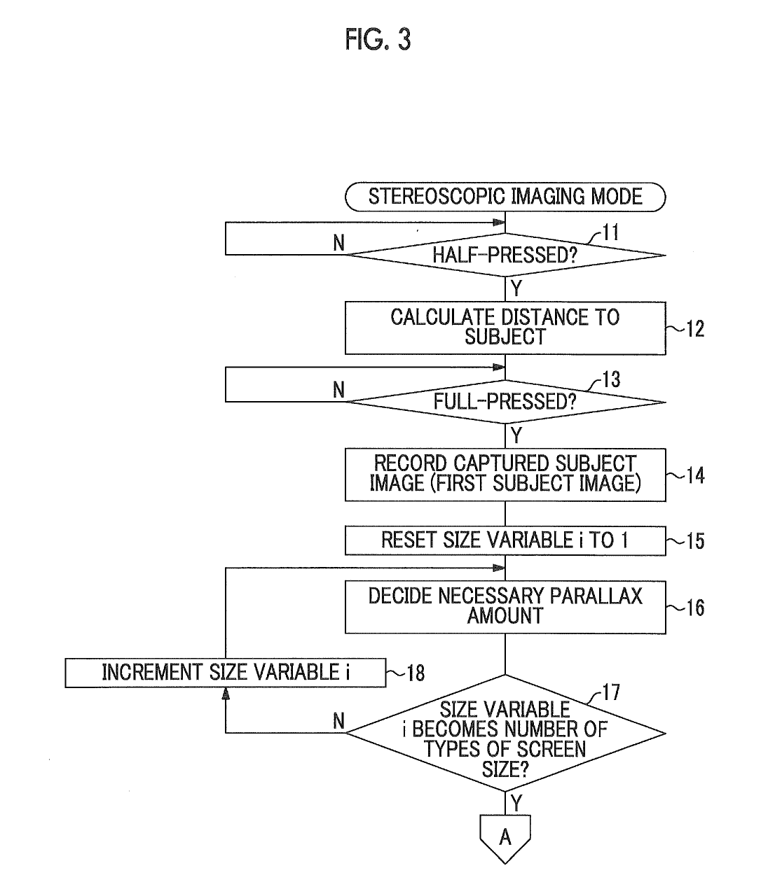

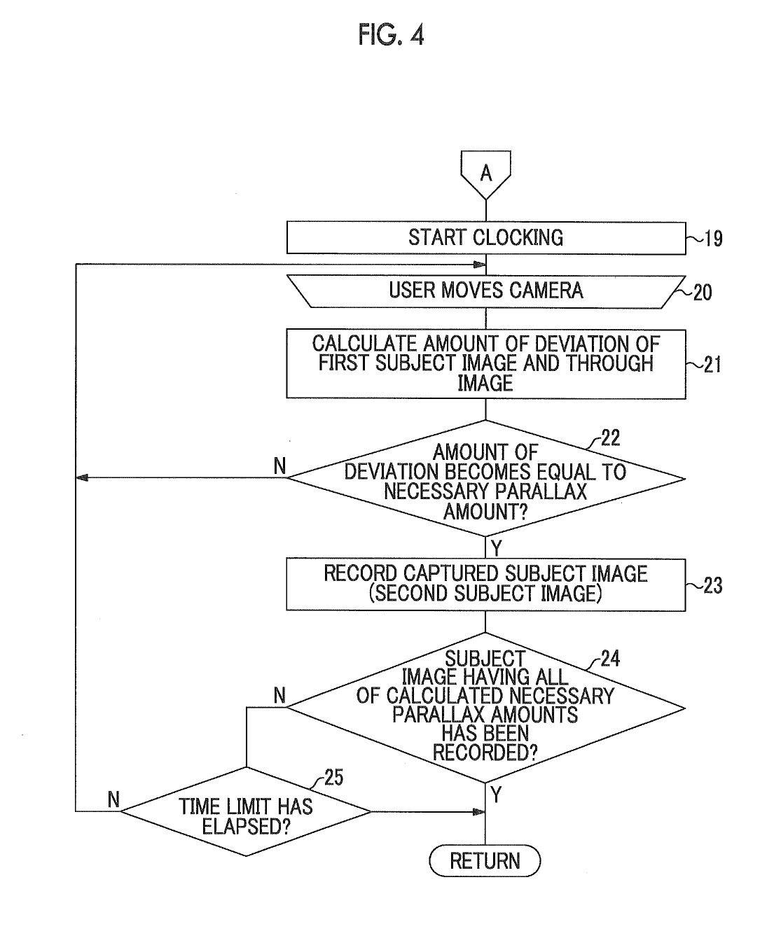

FIGS. 3 and 4 are flowcharts showing a processing procedure in a stereoscopic imaging mode in which left-eye images and right-eye images for stereoscopic display are recorded using the digital still camera 1 with a single imaging apparatus as described above.

If the stereoscopic imaging mode is executed, the subjects are imaged continuously (periodically), and the imaged subject images are displayed on the display screen in the rear surface of the digital still camera 1 as a motion image (through image). The user decides a camera angle while viewing a motion image being displayed on the display screen.

If a two-step stroke-type shutter release button is pressed (Step 11), the distance to a subject is calculated (Step 12). As the distance to the subject, while the distance to the character subject OB2 substantially at the center of the imaging range is calculated, the distance to another subject OB1 or OB3 in another portion of the imaging range may be calculated.

The distance to the subject can be calculated using the displacement of a focus lens.

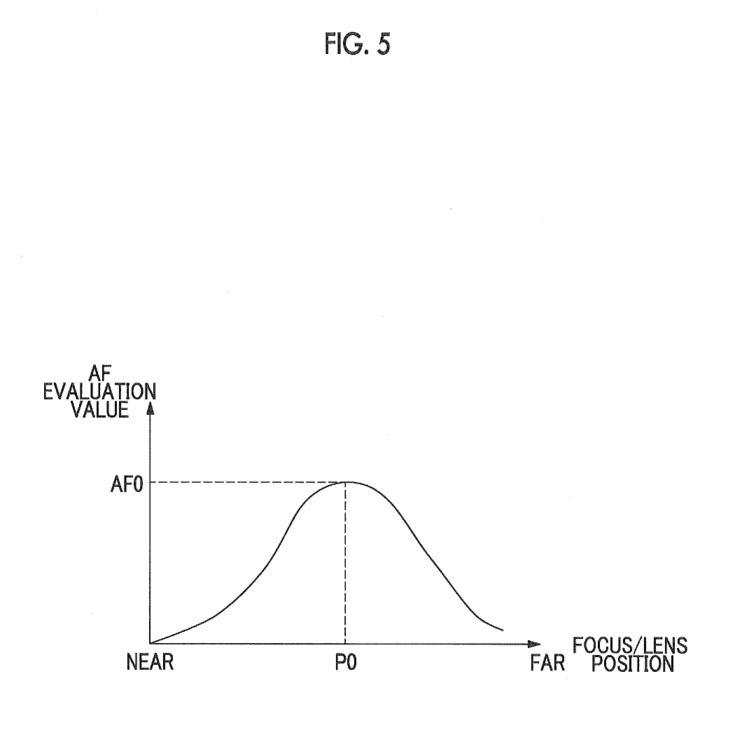

FIG. 5 shows the relationship between a focus lens position and an AF evaluation value representing a high-frequency component of imaged image data.

The subjects are imaged while moving the focus lens from a NEAR position (or a home position) to a FAR position. Of image data obtained by imaging the subjects, the high-frequency component (AF evaluation value) of image data in the central portion of the imaging range is extracted. The distance to the subject OB2 in the central portion of the imaging range can be calculated from the displacement of the focus lens at a focus lens position PO when the AF evaluation value becomes a maximum value AF0.

Returning to FIG. 3, if the shutter release button is full-pressed (YES in Step 13), image data representing the subject images (left-eye images or first subject images) imaged at the timing at which the shutter release button is full-pressed is recorded in a memory card of the digital still camera 1 (Step 14).

Then, a size variable i is reset to 1 (Step 15).

A necessary parallax amount is decided for each display screen size set in the display screen size setting (Step 16).

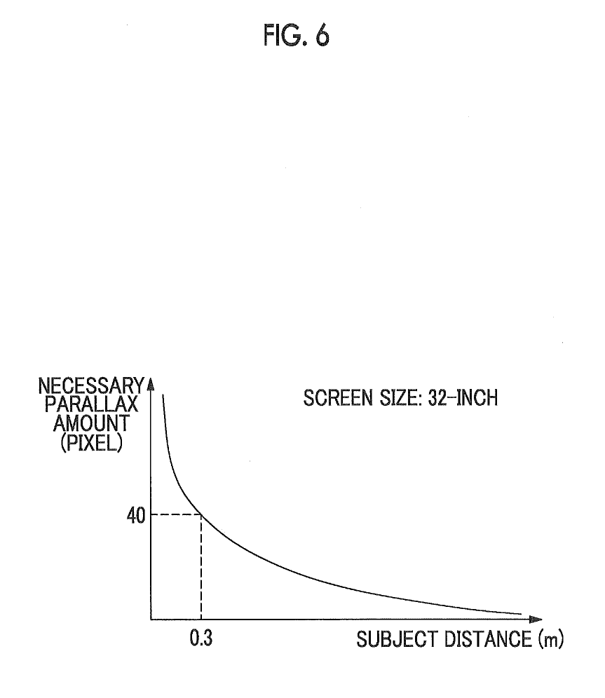

FIG. 6 shows the relationship between a necessary parallax amount and the distance to a subject.

The relationship between a necessary parallax amount and the distance to a subject is defined in advance for each display screen size of which a stereoscopic image is displayed. The example shown in FIG. 6 shows the relationship between a necessary parallax amount in terms of pixels when a stereoscopic image is displayed on the 32-inch display screen and the distance to a subject. For this reason, in the case of the 32-inch display screen, if the distance to a subject is 0.3 m, the necessary parallax amount is 40 pixels.

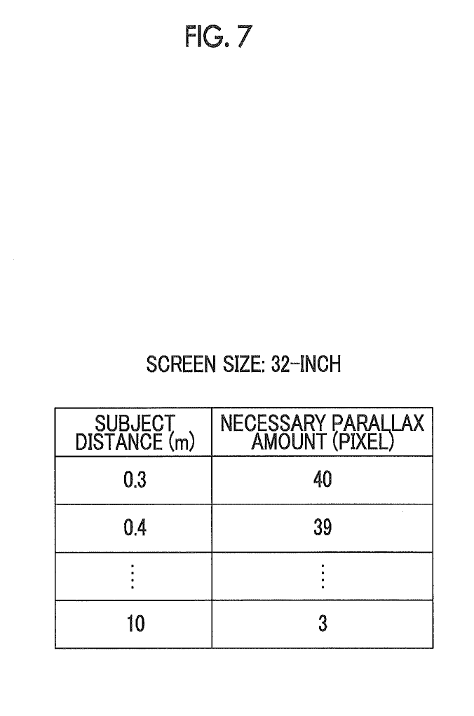

FIG. 7 is a table showing the relationship between a necessary parallax amount in terms of pixels and the distance to a subject.

In the table, the display screen size is 32-inch. A necessary parallax amount is set for every distance to a subject. The table is defined for every display screen size.

As described above, if the distance to a subject and the display screen size are decided, the necessary parallax amount is determined.

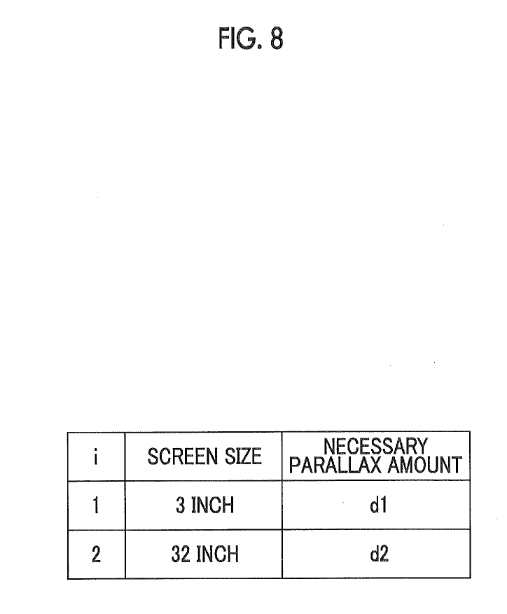

FIG. 8 is a table showing the relationship between a display screen size and a decided necessary parallax amount.

When the display screen size is set to 3-inch and 32-inch, the necessary parallax amount when the display screen size is 3-inch becomes d1 and the necessary parallax amount when the display screen size is 32-inch becomes d2 in accordance with the distance to a subject.

Returning to FIG. 3, when the necessary parallax amount when the display screen size is 3-inch is calculated as d1 (Step 16), it is confirmed whether or not the size variable i becomes the number (in this case, two) of types of the set display screen size (Step 17). If the size variable i does not become the number of types of the set display screen size (NO in Step 17), the size variable i increments (Step 18), and the necessary parallax amount for the next display screen size is calculated (Step 16).

If the necessary parallax amount between a left-eye image and a right-eye image necessary for displaying a stereoscopic image on all display screens of the set display screen size (3-inch and 32-inch) (YES in Step 17), timing starts (Step 19).

A message which requests the user to horizontally move the digital still camera 1 is displayed on the display screen, and the user moves the digital still camera 1 in the horizontal direction (the right direction, or when a reference image is a right-eye image, the left direction) according to the display (Step 20).

The image of the subjects are continued while the digital still camera 1 is moving, and so-called through images are continuously obtained. The amount of deviation between a first subject image and a through image is calculated (Step 21). The moving of the digital still camera 1 (Step 20) and the calculation of the amount of deviation between the first subject image and the through image are repeated (Step 21) until the calculated amount of deviation becomes equal to the necessary parallax amount.

If the calculated amount of deviation becomes equal to the necessary parallax amount (Step 22), image data representing a subject image (a second subject image or a right-eye image) imaged when the amount of deviation becomes equal to the necessary parallax amount is recorded in the memory card (Step 23). An image having an optimum parallax amount can be recorded without awareness of the user. Since an image according to a display screen size is recorded, it is possible to prevent an excessive increase in the parallax amount when a stereoscopic image is displayed on a large display screen. It is also possible to prevent imaging failure.

If subject images having all calculated necessary parallax amounts are not recorded (NO in Step 24), the processing from Step 20 is repeated unless the time limit elapses (NO in Step 25). If image data which represents subject images having all calculated necessary parallax amounts is recorded in the memory card, the processing in the stereoscopic imaging mode ends. As described above, when the set display screen size is 3-inch and 32-inch, the right-eye image for 3-inch having the parallax amount d1 and the right-eye image for 32-inch having the parallax amount d2 are obtained, the processing in the stereoscopic imaging mode ends,

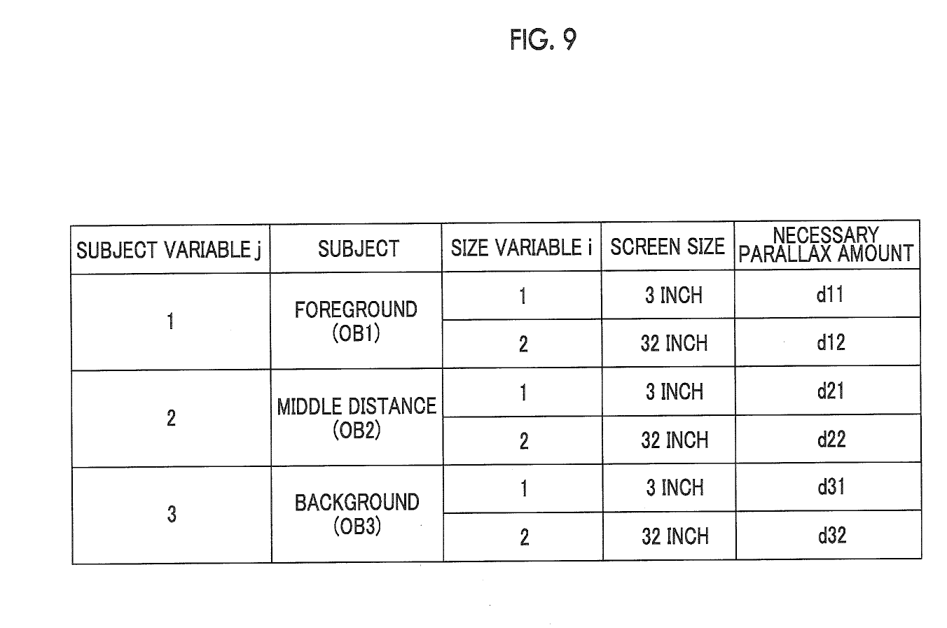

FIGS. 9 to 11 show a modification.

In the foregoing example, the parallax amount for stereoscopically displaying a single specific subject in the imaging range is calculated, and a single right-eye image is generated for each display screen size. In contrast, in this modification, a parallax amount for stereoscopically displaying each of a plurality of subjects in the imaging range is calculated. A single right-eye image is generated for each subject and for each display screen size. As shown in FIG. 1, it is assumed that a right-eye image having a parallax amount according to a display screen size is generated for each of the subjects OB1, OB2, and 093.

FIG. 9 is a table representing a necessary parallax amount, and corresponds to the table shown in FIG. 8.

A subject variable j for representing the number of principal subjects in the imaging range is introduced. In the case of the subjects OB1, OB2, and OB3, the subject variable j becomes 1 to 3. The number of principal subjects may be input by the user, and as described below, the number of peak values (maximum values) of the AF evaluation value equal to or greater than a predetermined threshold value may be used. The subjects are divided into a foreground subject (a subject close to the digital still camera 1) OB1, a middle distance subject (a subject neither close to nor far from the digital still camera 1) OB2, and a background subject (a subject far from the digital still camera 1) OB3 in accordance with the distance from the digital still camera 1 to the subject. For each of the subjects OB1, OB2, and OB3, a necessary parallax amount appropriate for a display screen size is calculated. The calculated necessary parallax amount is stored in the table shown in FIG. 9.

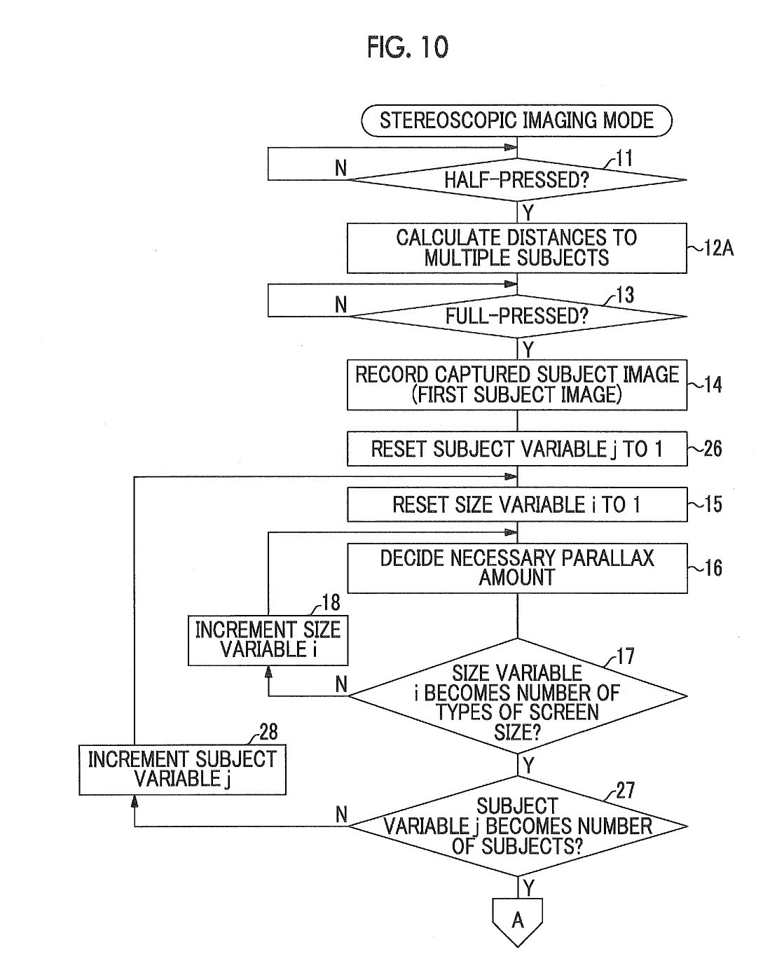

FIG. 10 is a flowchart showing a processing procedure in a stereoscopic imaging mode, and corresponds to the processing procedure of FIG. 3. In FIG. 10, the same steps as those shown in FIG. 3 are represented by the same reference numerals, and description thereof will not be repeated.

If the shutter release button is half-pressed (YES in Step 11), the distance to each of a plurality of principal subjects in the imaging range is calculated (Step 12A).

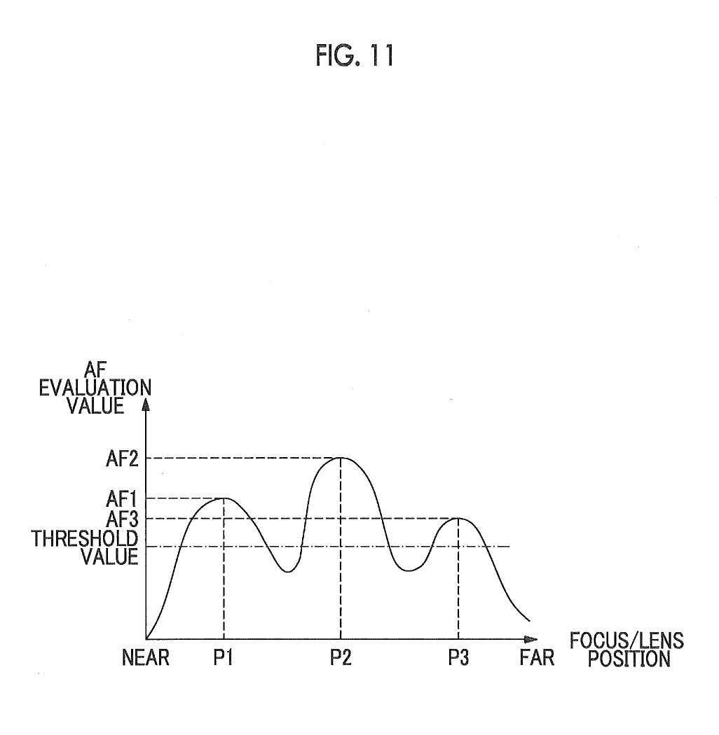

FIG. 11 shows the relationship between a focus lens position and an AF evaluation value which represents a high-frequency component extracted from imaged image data.

If the focus lens moves from the NEAR position to the FAR position during imaging, the high-frequency component is extracted from image data representing images in the entire imaging range, the graph having the relationship shown in FIG. 11 is obtained. In the graph shown in FIG. 11, the positions P1, P2, and P3 of the focus lens corresponding to comparatively high AF evaluation values AF1, AF2, and AF3 (equal to or greater than a predetermined threshold value) are obtained. The distances from the positions P1, P2, and P3 (from the displacement of the focus lens) to the subjects OB1, OB2, and OB3 are understood.

Returning to FIG. 10, if the shutter release button is pressed in the second step (YES in Step 13), a subject image imaged at the timing at which the shutter release button is pressed in the second step becomes a first subject image (right-eye image), and image data representing the first subject image is recorded in the memory card (Step 14).

The subject variable j and the size variable i are reset to 1 (Steps 26 and 15).

Then, the necessary parallax amount is calculated (Step 16). Initially, since the subject variable j is 1 and the size variable i is 1, for the foreground subject OB1, the necessary parallax amount appropriate for the display screen size of 3-inch is calculated (Step 16). From the graph having the relationship shown in FIG. 6 corresponding to the display screen size, the necessary parallax amount is calculated using the measured distance to the subject. If the size variable i does not become the number of types of the display screen size (NO in Step 17), the size variable i increments (Step 18), and the necessary parallax amount appropriate for display of the next display screen size is calculated (Step 16).

If the size variable i becomes the number of types of the display screen size (2 since the display screen size is 3-inch and 32-inch) (YES in Step 17), it is confirmed whether or not the subject variable j becomes the number of subjects (Step 27). If the subject variable j does not become the number of subjects (NO in Step 27), the subject variable j increments (Step 28). Accordingly, for the next subject, processing for calculating the necessary parallax amount for each display screen size is performed.

In this way, all of the necessary parallax amounts for the display screens for principal subjects in the imaging range are calculated. The calculated necessary parallax amounts are stored in the table shown in FIG. 9. As described above, imaging is repeated while the digital still camera 1 is moved in the horizontal direction by the user, and when subject images having the calculated necessary parallax amounts are imaged, image data representing the subject images is recorded in the memory card. In this example, image data representing a reference left-eye image (first image) and each of six right-eye images is recorded in the memory card. Of course, image data representing each of six left-eye images with a right-eye image as reference may be recorded in the memory card.

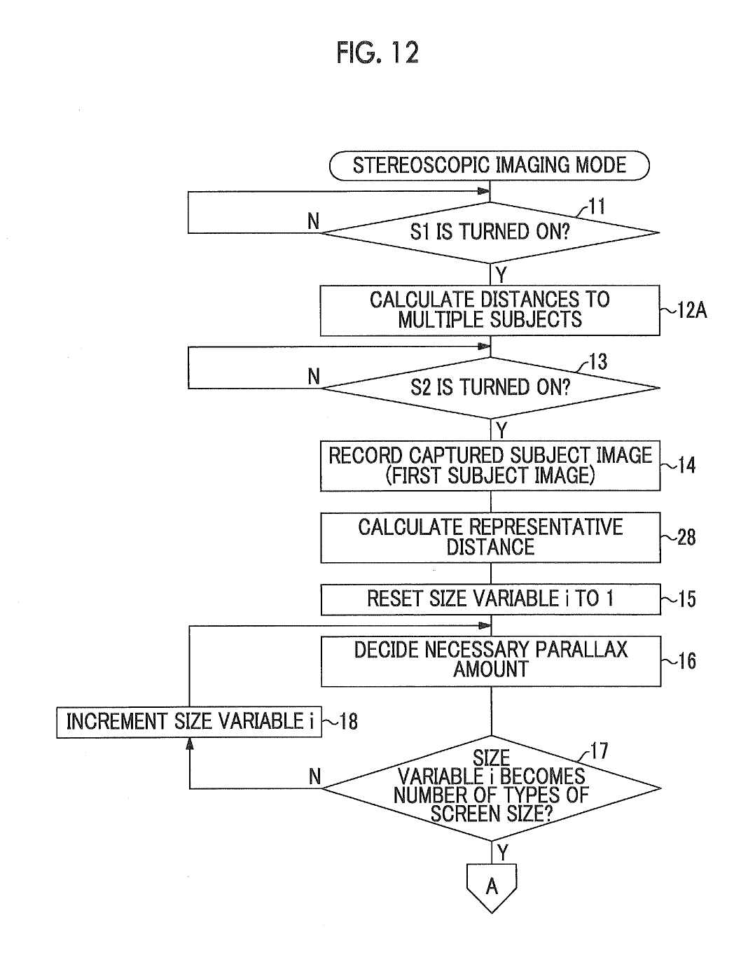

FIGS. 12 to 15 show another modification.

In this modification, when there are a plurality of principal subjects in the imaging range, a representative distance to a subject is calculated, and a necessary parallax amount is calculated from the calculated representative distance.

FIG. 12 is a flowchart showing a processing procedure in a stereoscopic imaging mode. In the drawing, the same steps as those shown in FIG. 3 are represented by the same reference numerals, and description thereof will not be repeated.

As described above, if the shutter release button is pressed in the first step (YES in Step 11), the distances to a plurality of principal subjects in the imaging range are calculated (Step 12A).

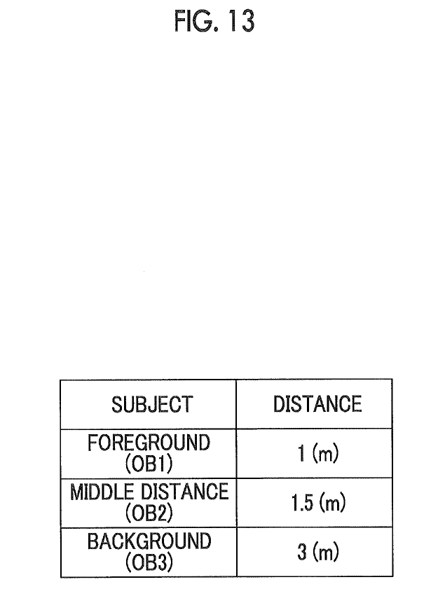

FIG. 13 is a table showing distances to a plurality of principal subjects.

As described above, if the distances to the principal subjects are measured, a table showing the distances is generated and stored in the digital still camera 1. For example, the distance to the foreground foreground subject OB1 is 1 m, the distance to the middle distance subject OB2 is 1.5 m, and the distance to the background subject OB3 is 3 m.

Returning to FIG. 12, if the shutter release button is pressed in the second step (YES in Step 13), image data representing a left-eye image (first subject image) is recorded in the memory card (Step 14).

Then, a representative distance representing the distance to the representative image is calculated (Step 28). As the representative distance, the average distance of the distances to a plurality of principal subjects in the imaging range, the distance to a subject closest to the digital still camera 1, or the like is considered. When the average distance is used as the representative distance, the parallax amount of the foreground subject increases. Meanwhile, when the representative distance is the closest distance, it is possible to prevent an increase in the parallax amount. Since the imaged subject images are displayed on the display screen in the rear surface of the digital still camera 1, a desired subject image may be selected from among the displayed subject image, and the distance to the selected subject image may be used as the representative image.

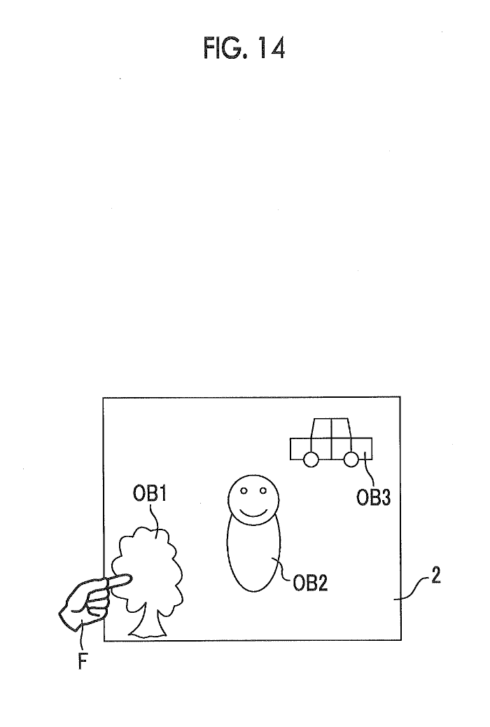

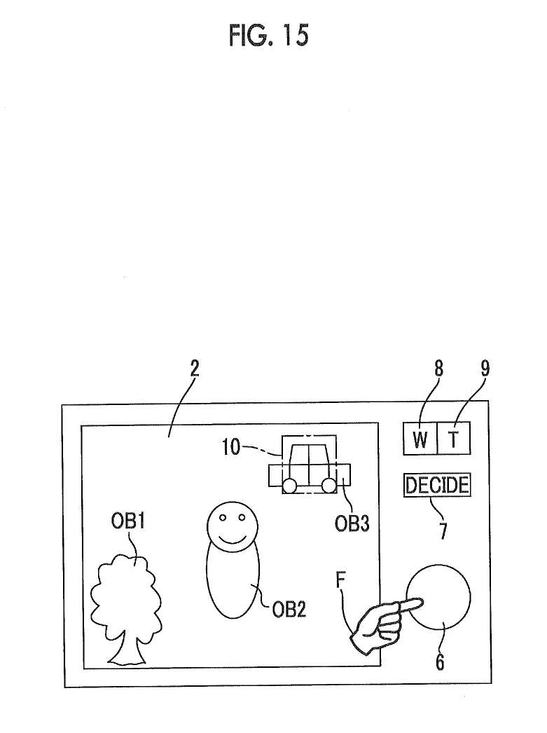

FIGS. 14 and 15 show an example of a method of selecting a representative image.

FIG. 14 shows an example of a subject image which is displayed on a display screen.

A plurality of subject images OB1, OB2, and OB3 (represented by the same reference numerals as the subjects) are displayed on the display screen 2. The user designates a representative image from among the subject images OB1, OB2, and OB3 with a finger F.

FIG. 15 shows another method of selecting a representative image, and is a rear view of the digital still camera 1.

The display screen 2 is provided over the entire rear surface of the digital still camera 1. A plurality of subject images OB1, OB2, and OB3 are displayed on the display screen 2. A move button 6 is provided in the lower portion on the right side of the display screen 2. A decide button 7 is provided above the move button 6. A wide button 8 and a tele button 9 are provided above the decide button 7. A cursor 10 is displayed on the display screen 2. The cursor 10 moves on the images displayed on the display screen 2 in accordance with operation of the move button 6 by the finger F of the user. The cursor 10 is operated by the move button 6 so as to be located on a desired subject image. If the cursor 10 is positioned on a desired subject image, the user presses the decide button 7 with the finger F. When this happens, a subject image on which the cursor 10 is positioned becomes the representative image.

The distance to the representative image selected in this way is known from the position of the focus lens with the peak value of the AF evaluation value which is the high-frequency component obtained by extracting image data representing a representative image portion touched with the finger F or a representative image portion designated by the cursor 10 among image data obtained by repeating imaging while moving the position of the focus lens as described above in the same manner as shown in FIG. 5.

If the representative distance to the representative image is calculated, as described above, the necessary parallax amount corresponding to the representative distance is calculated, and image data representing a subject image when the necessary parallax amount is reached are recorded in the memory card. Since image data which represents the subject image having the parallax amount corresponding to the representative distance is recorded in the memory card, there is no case where image data is recorded more wastefully than necessary.

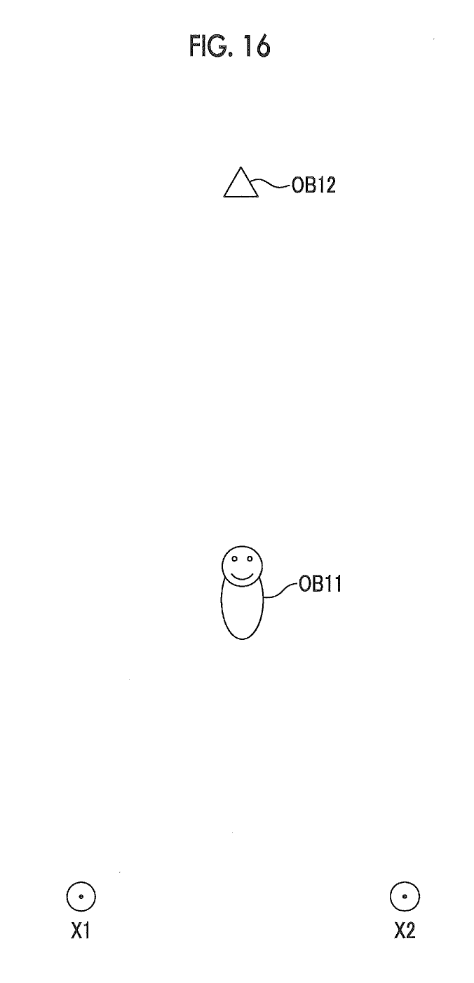

FIGS. 16 to 20 show a further modification.

In this modification, the necessary parallax amount calculated in the above-described manner is equal to or smaller than an allowable parallax amount value. When the parallax amount is large, while the viewer of the stereoscopic image feels a sense of discomfort, since the upper limit of the necessary parallax amount is restricted, it is possible to prevent the viewer of the stereoscopic image from feeling a sense of discomfort.

FIG. 16 shows the relationship of a subject and a photographing position in plan view.

The photographing position of the left-eye image is represented by X1, and the photographing position of the right-eye image is represented by X2. It is assumed that there are a first subject OB11 comparatively close to the photographing positions X1 and X2, and a second subject OB12 comparatively far from the photographing positions X11 and X12. The first subject OB11 and the second subject OB12 are imaged at the photographing position X1, and the left-eye image is obtained. The first subject OB11 and the second subject OB12 are imaged at the photographing position X2, and the right-eye image is obtained.

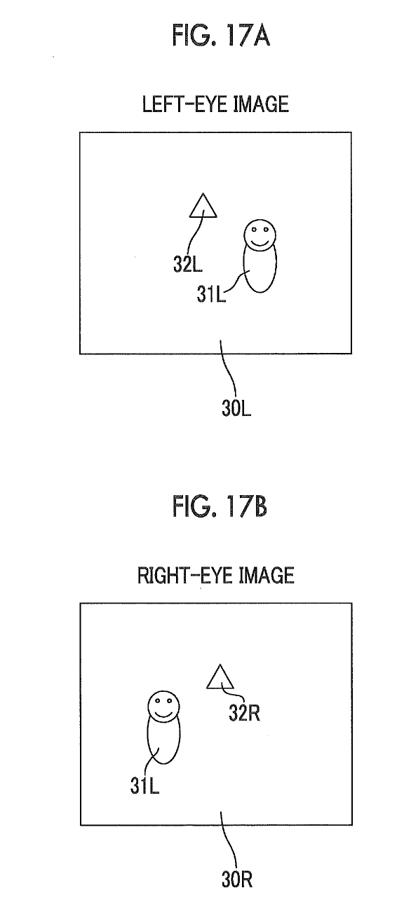

FIG. 17A shows an example of a left-eye image obtained through imaging, and FIG. 17B shows an example of a right-eye image obtained through imaging.

Referring to FIG. 17A, a left-eye image 30L includes a first subject image 31L representing the first subject OB11 and a second subject image 32L representing the second subject OB12. The second subject image 32L is located on the left side of the first subject image 31L.

Referring to FIG. 17B, a right-eye image 30R includes a first subject image 31R representing the first subject OB11 and a second subject image 32R representing the second subject OB12. In the right-eye image 30R, unlike the left-eye image 30L, the second subject image 32R is located on the right side of the first subject image 31L.

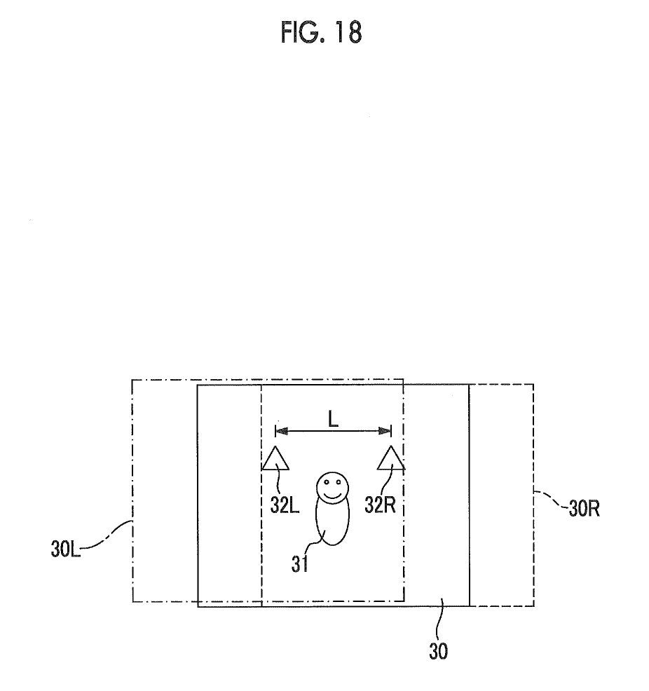

FIG. 18 shows a stereoscopic image 30 in which a left-eye image and a right-eye image are superimposed.

The left-eye image 30L and the right-eye image 30R are superimposed such that the first subject image 31L in the left-eye image 30L shown in FIG. 17A and the first subject image 31R in the right-eye image 30R shown in FIG. 17B are consistent with each other (cross point). The first subject image 31 representing the first subject OB11 has no horizontal deviation. Meanwhile, the second subject image 32L and the second subject image 32R representing the second subject image OB12 are deviated from each other by a parallax amount L. if the parallax amount L is excessively large, as described above, the viewer of the stereoscopic image feels a sense of discomfort.

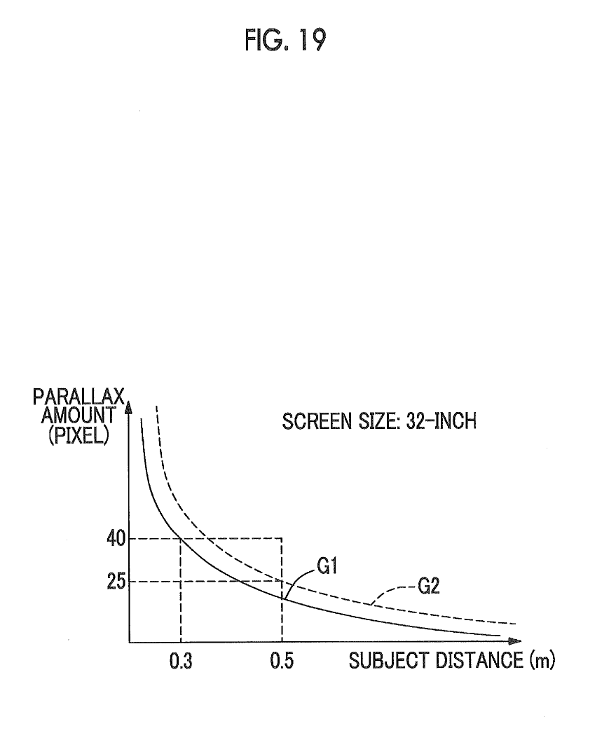

FIG. 19 shows the relationship between a parallax amount and a subject distance.

A graph G1 which represents a parallax amount for allowing the subject to be viewed stereoscopically is defined to correspond to the distance to the subject. For example, if the distance to the first subject OB11 is 0.3 m, the parallax amount becomes 40 pixels. When the distance to the second subject OB12 farther than the first subject OB11 is 1.5 m, it is understood from a graph G2 that the allowable parallax amount value of the subject image of the second subject OB12 is 25 pixels. If the parallax amount of the subject image of the first subject OB11 is 40 pixels, the parallax amount of the second subject OB12 exceeds 25 pixels as the allowable parallax amount value. For this reason, in this example, the parallax amount of the first subject OB11 is set to the allowable parallax amount value 25 of the second subject OB12.

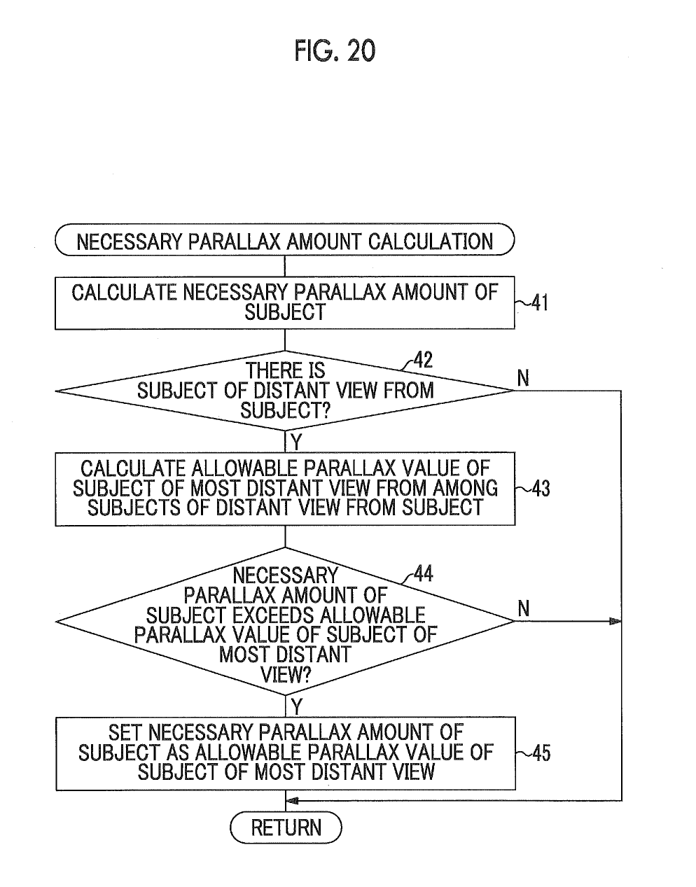

FIG. 20 is a flowchart showing a necessary parallax amount calculation processing procedure (a processing procedure of Step 16 in FIG. 10 or 12).

The necessary parallax amount of the subject is calculated from the distance to the subject using the graph G1 shown in FIG. 19 (Step 41). It is confirmed whether or not there are principal subjects farther than the subject with the calculated necessary parallax amount (subjects whose AF evaluation value is equal to or greater than a predetermined threshold value) (Step 42).

When there is a principal subject farther than the subject with the calculated necessary parallax amount (YES in Step 42), the allowable parallax value of the farthest subject from among the principal subjects farther than the subject with the calculated necessary parallax amount is calculated using the graph G2 (Step 43).

If the calculated necessary parallax amount exceeds the allowable parallax value (YES in Step 44), as described above, the allowable parallax value of the farthest subject becomes the necessary parallax amount (Step 45).

Where there are no principal subjects farther than the subject with the calculated necessary parallax amount (NO in Step 42), the processing of Steps 43 to 45 is skipped. If the necessary parallax amount does not exceed the allowable parallax value of the farthest principal subject (NO in Step 44), the processing of Step 45 is skipped. Of course, the same processing may be performed on principal subjects closer to the subject with the calculated necessary parallax amount.

It is possible to prevent an increase in parallax when displaying the stereoscopic image.

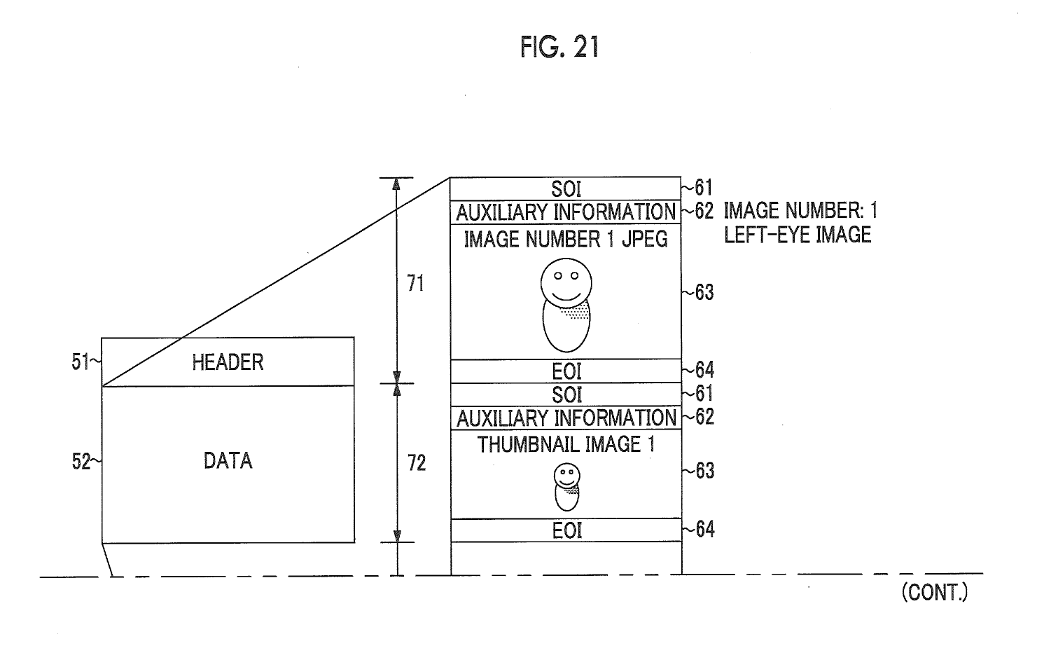

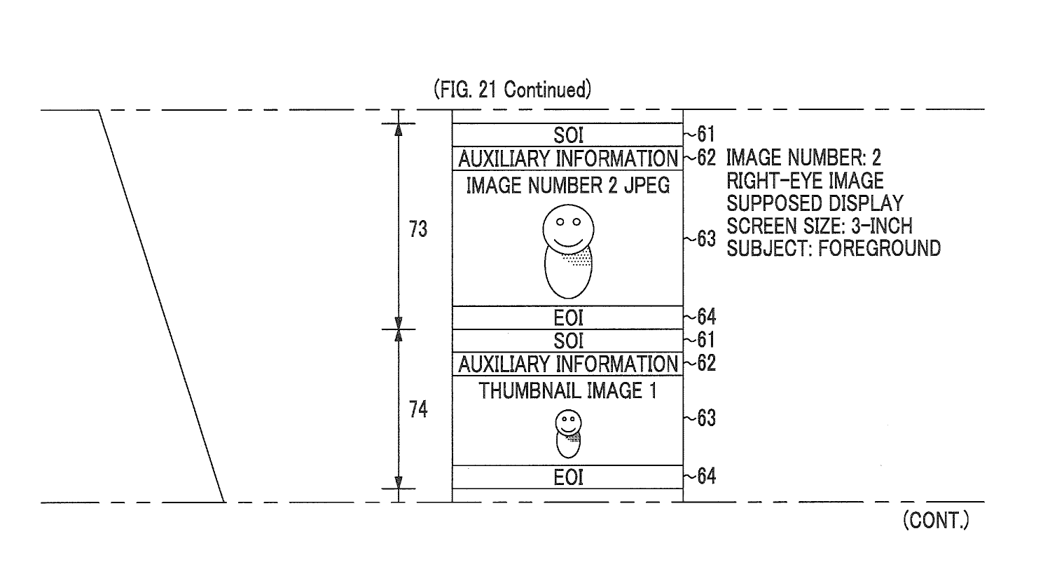

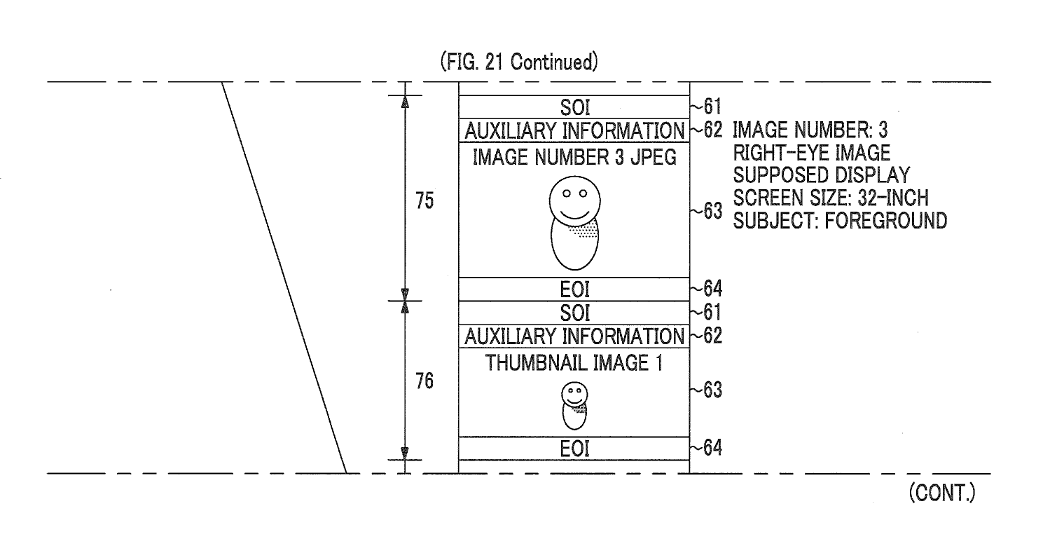

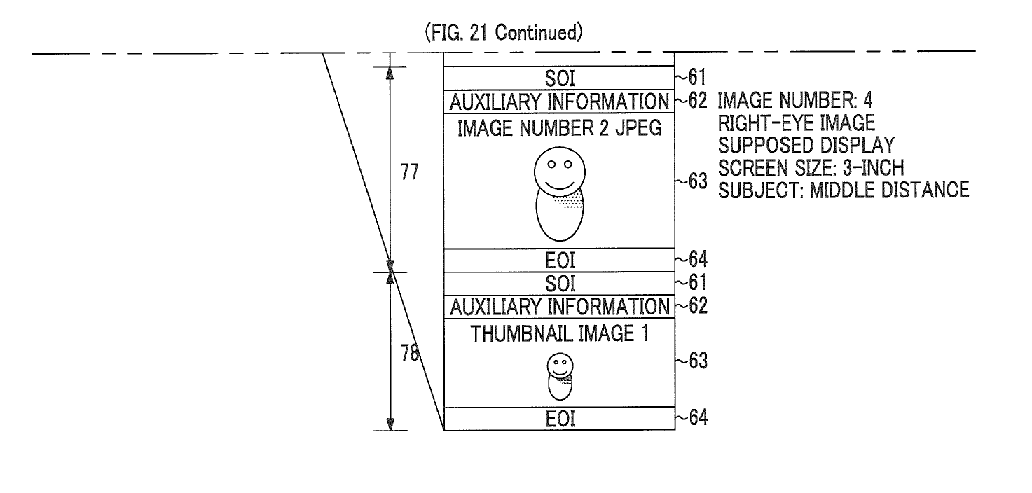

FIG. 21 shows an example of the file structure of a file which stores image data representing each of the left-eye image and the right-eye image described above.

A file includes a header recording region 51 and a data recording region 52.

The header recording region 51 stores information for managing the file.

In the data recording region 52, image data representing a plurality of images, or the like is recorded.

A plurality of recording regions 71 to 78 are formed in the data recording region 52. The first recording region 71 and the second recording region 72 are the regions for the left-eye image. The third recording region 73 to the eighth recording region 78 are the regions for the right-eye image. If there are a large number of right-eye images which are represented by right-eye image data stored in the file, the number of recording regions may of course further increase.

In the first recording region 71, an SOI region 61 where SOI (Start Of Image) data representing the start of image data is stored, an auxiliary information region 62 where auxiliary information, such as an image number and image information representing whether or not image data to be successively recorded is a right-eye image or a left-eye image is stored, a region 63 where image data is recorded, and an EOI region 64 where EOI (End Of Image) data representing the end of image data is stored are formed. In the region 63 where image data of the first recording region 71 is recorded, image data representing the left-eye image is recorded. In the region 63 where image data of the second recording region 72 is recorded, image data which represents a thumbnail image of the left-eye image represented by left-eye image data recorded in the first recording region 71 is recorded.

Image data representing the left-eye image or the right-eye image obtained through imaging is recorded in the odd-numbered recording regions among the first recording region 71 to the eighth recording region 78, and image data representing the thumbnail image of the left-eye image or the right-eye image obtained through imaging is recorded in the even-numbered recording regions.

The third recording region 73 to the eighth recording region 78 are the same as the first recording region 71 and the second recording region 72 except that image data of the right-eye image is recorded. Of course, in regard to the right-eye image, data representing the display screen size and the position of a principal subject (foreground, middle distance, background, or the like) may be recorded in the auxiliary information in addition to the image number and the right-eye image.

Image data representing the left-eye image and image data representing a plurality of right-eye images obtained in the above-described manner are stored in the file and recorded in the memory card.

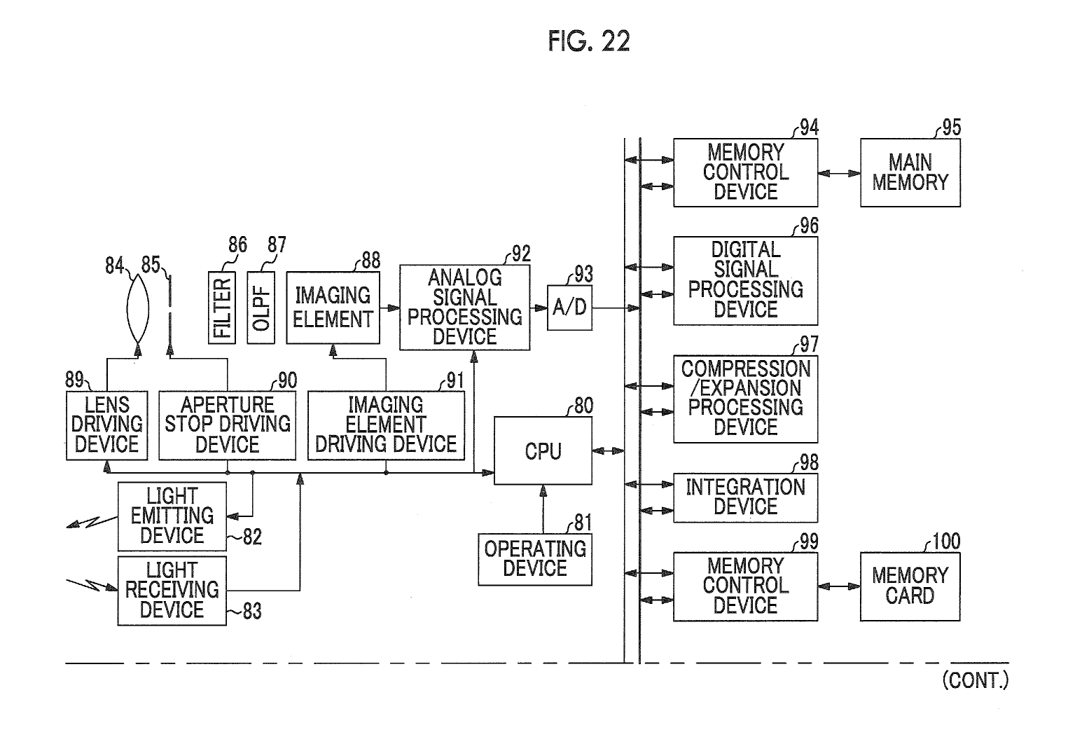

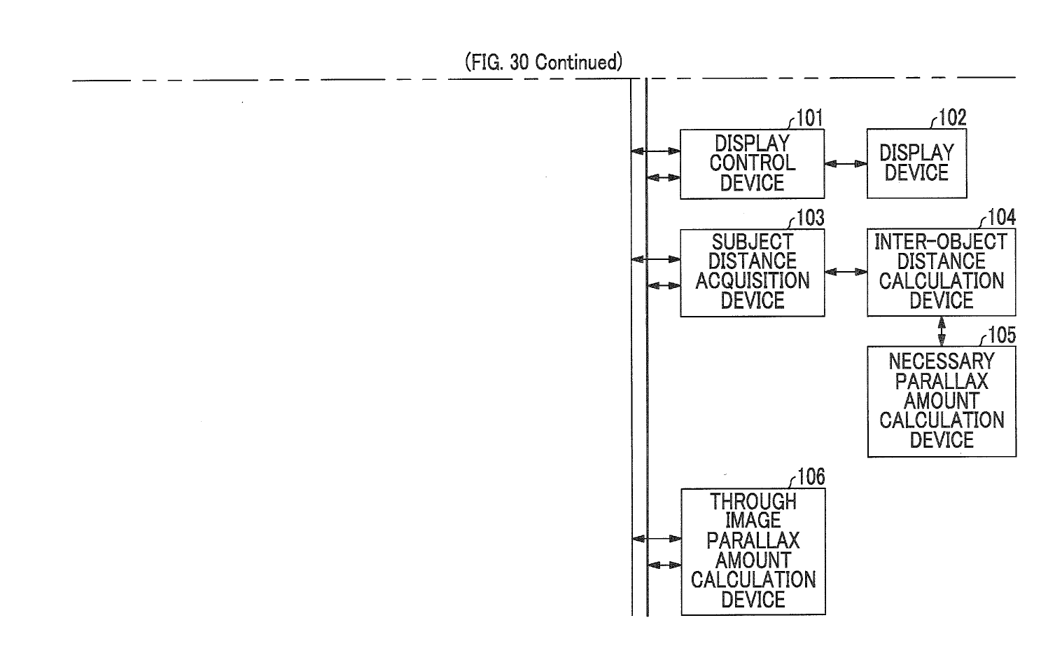

FIG. 22 is a block diagram showing the electrical configuration of a digital still camera in which the above-described imaging is performed.

The overall operation of the digital still camera is controlled by a CPU 80, The digital still camera is provided with an operation device 81 which includes various buttons including a mode setting button which is used to set a mode, such as a stereoscopic imaging mode for parallax image generation, an imaging mode in which normal two-dimensional imaging is performed, a two-dimensional reproduction mode in which two-dimensional reproduction is performed, a stereoscopic reproduction mode in which a stereoscopic image is displayed, or a setting mode, a two-step stroke-type shutter release button, and the like. An operation signal which is output from the operating device 81 is input to the CPU 80.

The digital still camera includes a single imaging element (a CCD, a CMOS, or the like) 88 which images a subject and outputs an analog video signal representing the subject. A focus lens 84, an aperture stop 85, an infrared cut filter 86, and an optical low-pass filter 87 are provided in front of the imaging element 88. The lens position of the focus lens 84 is controlled by a lens driving device 89. The aperture amount of the aperture stop 85 is controlled by an aperture stop driving device 90. The imaging element 88 is controlled by an imaging element driving device 91.

If the stereoscopic imaging mode is set, a subject is imaged periodically by the imaging element 88. A video signal representing a subject image is output periodically from the imaging element 88. The video signal output from the imaging element 88 is subjected to predetermined analog signal processing in an analog signal processing device 92, and is converted to digital image data in an analog/digital conversion device 96. Digital image data is input to a digital signal processing device 96. In the digital signal processing device 96, predetermined digital signal processing is performed on digital image data. Digital image data output from the digital signal processing device is given to a display device 102 through a display control device 101. An image obtained through imaging is displayed on the display screen of the display device 102 as a motion image (through image display).

If the shutter release button is pressed in the first step, as described above, the subject is imaged while the focus lens 84 is moving. In a subject distance acquisition device 103, a high-frequency component is extracted from image data obtained through imaging, and the distance to the subject is calculated from the peak value or the like of the high-frequency component and the displacement of the focus lens. Image data is input to an integration device 98, and photometry of the subject is conducted. The aperture amount of the aperture stop 85 and the shutter speed (electronic shutter) of the imaging element 88 are decided based on the obtained photometric value.

If the shutter release button is pressed in the second step, image data imaged at the second timing represents the left-eye image. Image data which represents the left-eye image is given to and temporarily stored in a main memory 95 under the control of a memory control device 94. Image data is read from the main memory 95 and compressed in a compression/expansion processing device 97. Compressed image data is recorded in a memory card 100 by a memory control device 99.

Data representing the distance to the principal subject acquired in the subject distance acquisition device 103 (or the distance to one subject at the center of the imaging range) is input to a necessary parallax amount calculation device 105. In the necessary parallax amount calculation device 105, as described above, the necessary parallax amount is calculated. Data representing the distance to the principal subject is also given to a representative distance calculation device 104. The distance to a representative subject is calculated by the representative distance calculation device 104. Of course, as described above, when a representative subject is selected from among a plurality of principal subjects displayed on the display screen of the display device 102, the distance to the selected subject is calculated as the representative distance.

If image data representing the left-eye image is recorded in the memory card 100, the digital still camera itself is moved in the horizontal direction (right direction) by the user. The subject is continuously imaged while the camera is moving, and the subject images are continuously obtained. Image data obtained through continuous imaging is input to a through image parallax amount calculation device 106. In the through image parallax amount calculation device 106, it is confirmed whether or not the input subject image becomes the calculated necessary parallax amount. If the input subject image becomes the necessary parallax amount, image data representing the input subject image is recorded in the memory card 100 as right-eye image data. As described above, image data representing the right-eye image is recorded in the memory card 100 so as to have the parallax amount according to the display screen size.

The digital still camera also includes a light emitting device 82 and a light receiving device 83.

If the stereoscopic reproduction mode is set, left-eye image data recorded in the memory card 100 and, when right-eye image data corresponding to the display screen size of the display device 102 is recorded, right-eye image data are read. Read left-eye image data and right-eye image data are expanded in the compression/expansion processing device 97. Expanded left-eye image data and right-eye image data are given to the display device 102, and a stereoscopic image is displayed. When right-eye image data corresponding to the display screen size of the display device 102 is not recorded in the memory card 100, right-eye image data recorded in the memory card 100 may be read, and the parallax between the left-eye image and the right-eye image may be adjusted so as to become the parallax amount appropriate for the display screen size of the display device 102.

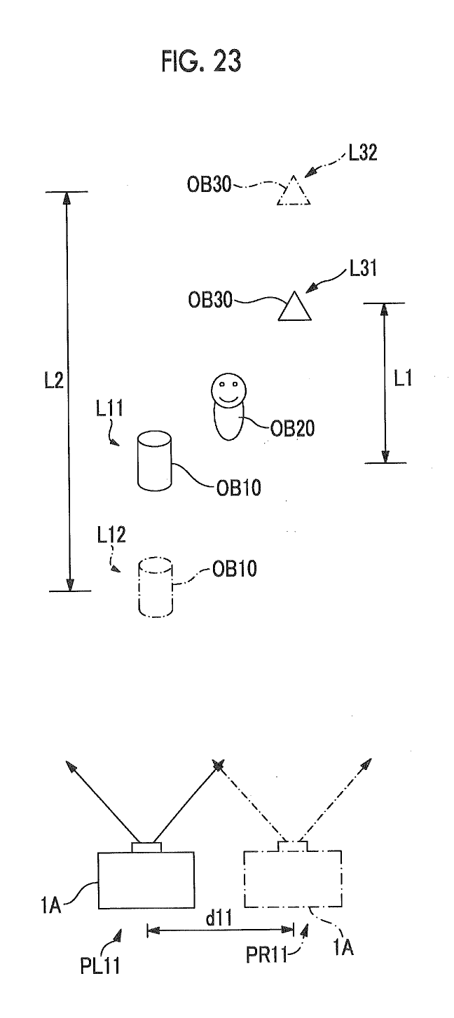

FIGS. 23 to 30 show a second example.

In this example, the necessary parallax amount is decided based on the distance (inter-object distance, distance information) between an object (an object closest to the digital still camera 1 among objects whose AF evaluation value is equal to or greater than a threshold value, called the closest object) closest to the digital still camera (stereoscopic imaging apparatus) 1 among a plurality of objects in the imaging range and an object (an object farthest from the digital still camera 1 among the objects whose AF evaluation value is equal to or greater than the threshold value, called the farthest object) farthest from the digital still camera 1.

FIG. 23 shows the relationship between a digital still camera 1A including a single imaging apparatus and a plurality of objects in the imaging range.

There are a first object OB10, a second object OB20, and a third object OB30 in front of the digital still camera 1. The first object OB10 is closest to the digital still camera 1, the second object OB20 is second closest to the digital still camera 1, and the third object OB30 is farthest from the digital still camera 1. The first object OB10 is the closest object, and the third object OB30 is the farthest object.

When the first object OB10 is at a position indicated by reference numeral L11, and the third object OB30 is at a position indicated by reference numeral L31, the inter-object distance between the closest object and the farthest object becomes a comparatively short distance L1. Meanwhile, if the first object OB10 is at a position indicated by reference numeral L12 closer to the digital still camera 1 than reference numeral L11, and the third object OB30 is at a position indicated by reference numeral L32 farther from the digital still camera 1 than reference numeral L31, the inter-object distance between the closest object and the farthest object becomes a comparatively long distance L2.

When the inter-object distance is short, even if the left-eye image and the right-eye image are obtained in the above-described manner, the relative parallax between a principal subject (the second object OB20, and it is assumed that the principal subject is between the closest object and the farthest object) and the closest object or the farthest object decreases. For this reason, in this example, when the inter-object distance is short, the necessary parallax amount between the right-eye image and the left-eye image for forming the stereoscopic image increases. Conversely, when the inter-object distance is long, the relative parallax between the principal subject and the closest object or the farthest object increases. For this reason, in this example, when the inter-object distance is long, the necessary parallax amount between the right-eye image and the left-eye image for forming the stereoscopic image decreases.

As in the above description, first, the digital still camera 1A is positioned at the reference position PL11 and the objects OB10, OB20, and OB30 in the imaging range are continuously imaged. The objects OB10, OB20, and OB30 are detected from a subject image for object detection which is one subject image among the continuously imaged subject images. If a recording instruction is given, image data which represents the subject images of the objects OB10, OB20, and OB30 imaged at the timing at which the recording instruction is given is recorded. The subject images obtained at the reference position PL11 through imaging become left-eye images (may become right-eye images).

As described below, for example, a parallax amount d11 appropriate for displaying a stereoscopic image on a display screen of predetermined size is decided in accordance with the inter-object distance.

As in the above-described example, the user moves the digital still camera 1A in the right direction while continuously (periodically) imaging the objects OB10, OB20, and OB30. While the digital still camera 1 is moving in the right direction, the subjects OB10, OB20, and OB30 are imaged. When the digital still camera 1 is at a position PR11, if the parallax between the subject images obtained through imaging becomes the parallax amount d11 decided as described below, the subject images obtained through imaging become right-eye images (second subject images) which are displayed on a display screen of predetermined size, and are recorded as image data representing the right-eye images. A parallax amount appropriate for a display screen of different size is decided based on the inter-object distance, and if subject images having the decided parallax amount are imaged, image data representing the imaged subject images is recorded. Of course, a parallax amount may be decided based on the inter-object distance regardless of the size of the display screen. A setting unit which sets the size of the display screen for displaying the stereoscopic image may be provided in the digital still camera 1. In this case, a parallax amount is decided from the size of the display screen set by the setting unit and the inter-object distance. Of course, a table which represents the relationship between the size of the display screen, the inter-object distance, and the parallax amount may be defined in advance, and a parallax amount may be decided using the table.

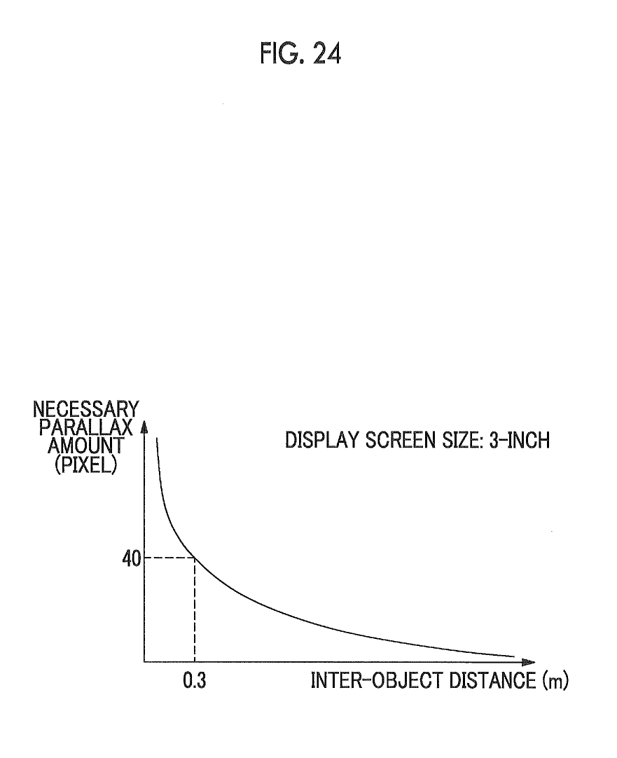

FIG. 24 shows the relationship between a necessary parallax amount and an inter-object distance.

The relationship between a necessary parallax amount and an inter-object distance is defined in advance for each display screen size of which the stereoscopic image is displayed. The example of FIG. 24 shows the relationship between a necessary parallax amount and an inter-object distance in terms of pixels when a stereoscopic image is displayed on a 3-inch display screen. For example, if the inter-object distance is 0.3 m, the necessary parallax amount is 40 pixels.

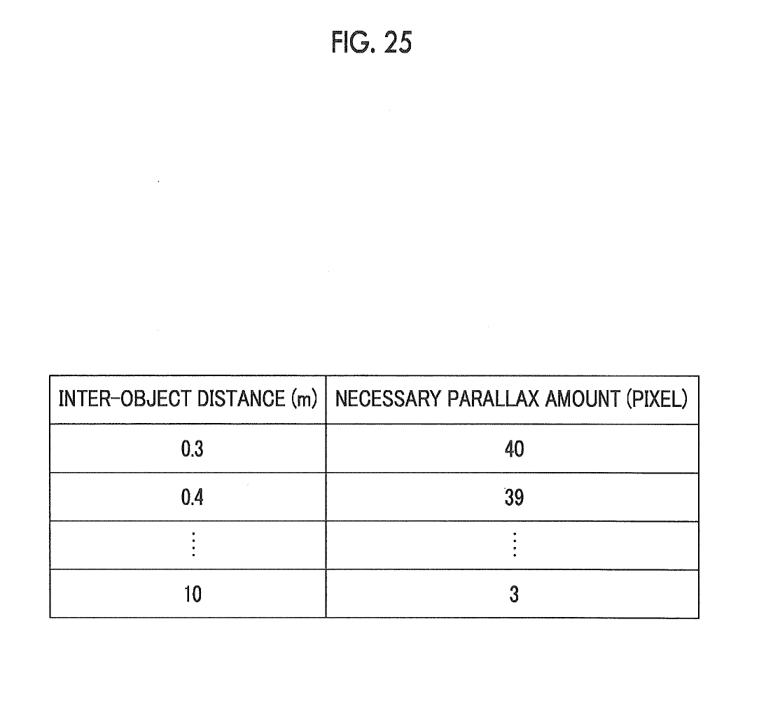

FIG. 25 is a table showing the relationship between a necessary parallax amount and an inter-object distance in terms of pixels.

In the table, the display screen size is 3-inch. A necessary parallax amount is defined for each inter-object distance. The table is defined for each display screen size.

As described above, if the inter-object distance which is the distance between the closest object and the farthest object, and the display screen size are decided, the necessary parallax amount is decided. Of course, as described above, the necessary parallax amount is decided depending on only the inter-object distance without taking into consideration the display screen size.

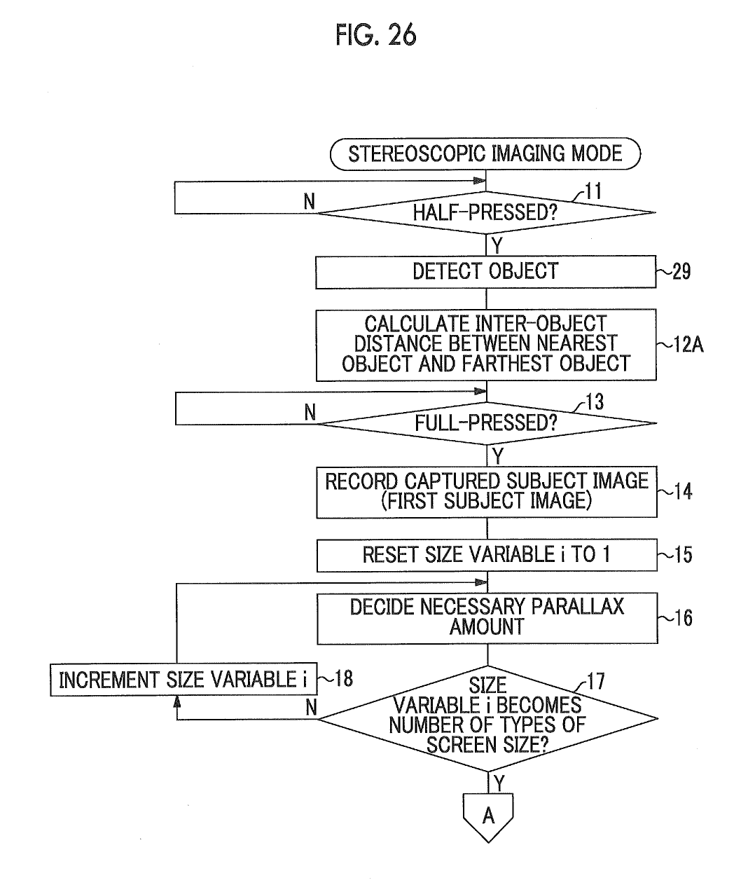

FIG. 26 is a flowchart showing a part of a processing procedure in stereoscopic imaging mode in which a left-eye image and a right-eye image for stereoscopic display are recorded using the digital still camera 1 having a single imaging apparatus. Since FIG. 26 corresponds to FIG. 3, the same steps as in the processing of FIG. 3 are represented by the same reference numerals, and description thereof will not be repeated as necessary.

If the camera angle is decided while imaging of a plurality of objects is continuously repeated, the shutter release button is half-pressed (Step 11). When this happens, all objects which satisfy a predetermined condition are detected from a subject image imaged at the timing at which the shutter release button is half-pressed (a subject image for object detection, and a subject image is not limited to a subject image imaged at the timing at which the shutter release button is half-pressed, and may be one subject matter among subject images to be continuously imaged) (Step 29). The inter-object distance which represents the distance between the closest object and the farthest object from among the detected objects is calculated (Step 12A).

The inter-object distance can be calculated as follows.

As described with reference to FIG. 11, first, the focus lens moves between the NEAR position closest to the imaging element and the FAR position farthest from the imaging element by a predetermined distance each time. An object is imaged at each movement position, and a high-frequency component is extracted from image data obtained through imaging. An AF evaluation value which represents the degree of focusing at each movement position of the focus lens is obtained from the high-frequency component. The positions of the positions P1, P2, and P3 (the displacement of the focus lens) of the focus lens which give the maximum value of a curve of the AF evaluation value beyond the threshold value correspond to the distances to the objects OB10, OB20, and OB30. The detected distance between the object OB10 and the object OB30 becomes the inter-object distance. Of course, the distance to each of the objects OB10, OB20, and OB30 is known from the displacement of the focus lens. The object detection itself can be realized in the above-described manner.

If the shutter release button is full-pressed (recording instruction) (YES in Step 13), a subject image imaged at the timing at which the shutter release button is full-pressed becomes a first subject image and is recorded in the memory card (Step 14). As described above, the size variable i is reset to 1 (Step 15), and the necessary parallax amount is decided from the table (see FIG. 25) corresponding to the size of the display screen decided with the size variable i (Step 16). Although in the above-described example, when the shutter release button is half-pressed, the inter-object distance between the closest object and the farthest object is calculated, and when the shutter release button is full-pressed, the first subject image is recorded in the memory card, it is preferable that, when the shutter release button is full-pressed, the first subject image is recorded in the memory card, all objects (for example, a face image of a character and an object having a spatial frequency equal to or greater than a threshold value) which satisfy a predetermined condition are detected from the first subject image, the distance between an object closest to the digital still camera (imaging apparatus) 1 among a plurality of detected objects and an object farthest from the digital still camera 1 is calculated, and the parallax amount is decided from the calculated distance.

While the size variable i is incremented (Step 18) until the size variable i becomes equal to the number of types of the display screen size (Step 17), the necessary parallax amount corresponding to the size of the display screen and the inter-object distance is decided.

If the necessary parallax amount is decided, as described above (see FIG. 4), imaging is repeated while the user holds the digital still camera. An image imaged when the amount of deviation between the first subject image and a through image becomes equal to the decided necessary parallax amount becomes a second subject image and is recorded in the memory card. The first image is a left-eye image (or a right-eye image) which forms a stereoscopic image, and the second image is a right-eye image (or a left-eye image) which forms a stereoscopic image.

Although in the above-described example, a case where the inter-object distance which is the distance between the closest object and the farthest object can be calculated has been described, when only one object is detected in the imaging range, it is not possible to calculate the inter-object distance. In this case, a necessary parallax amount decided in advance (preferably, a necessary parallax amount defined in advance corresponding to the display screen) is decided.

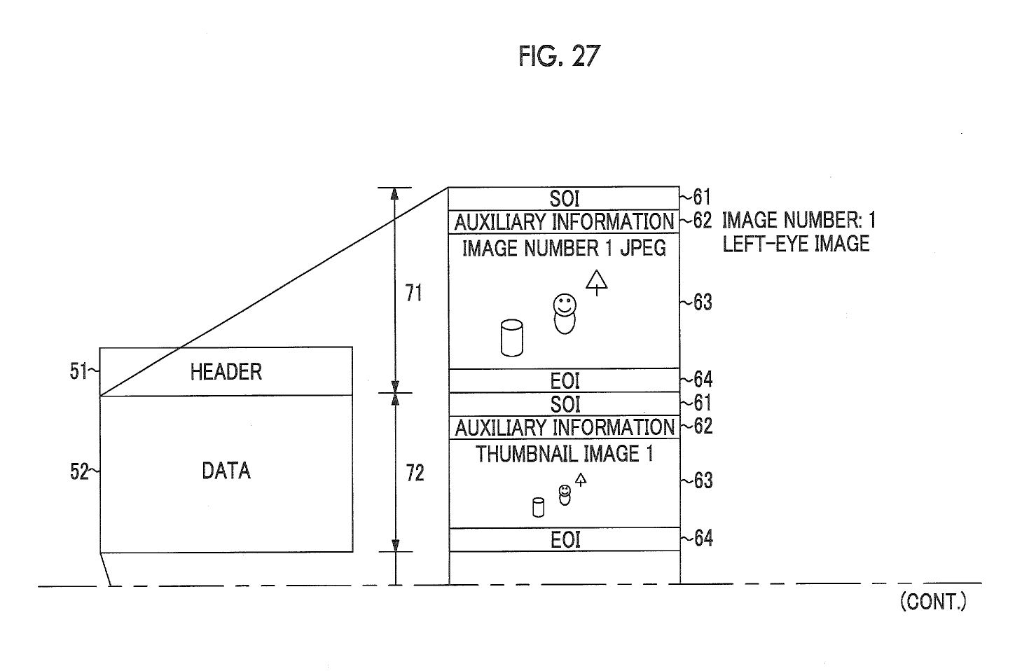

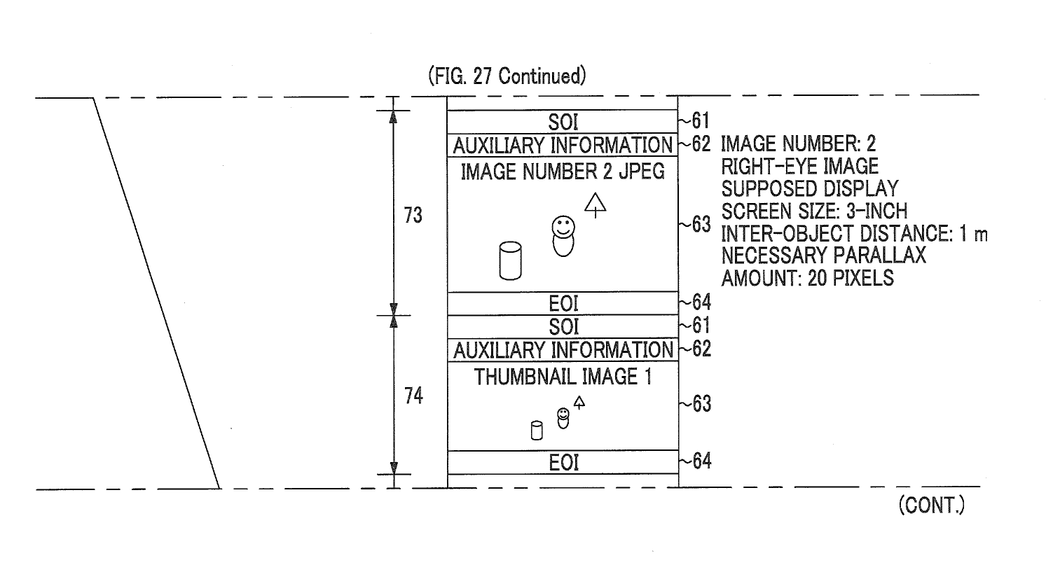

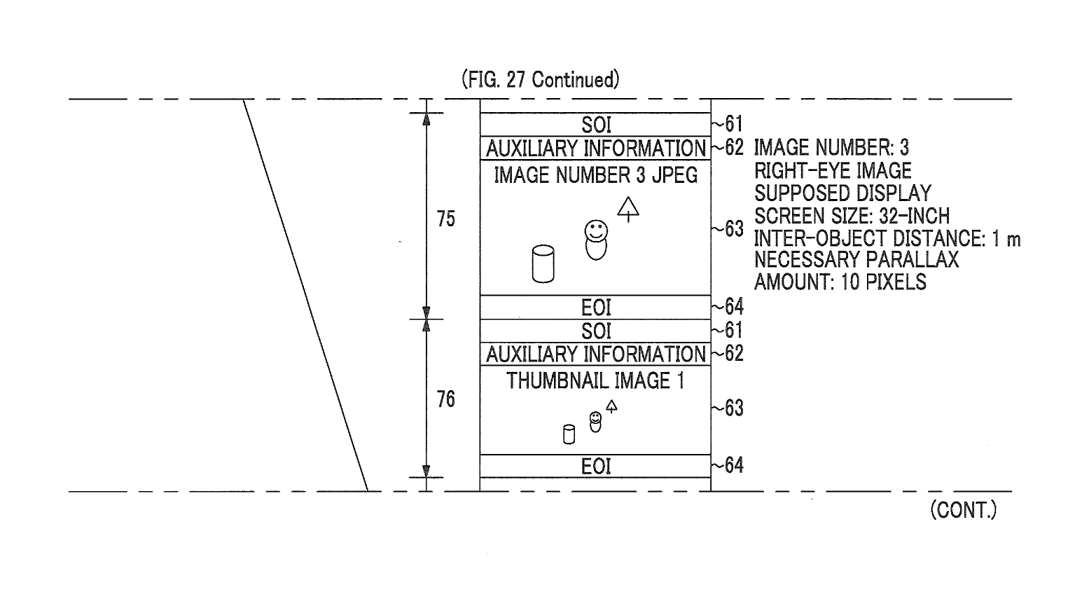

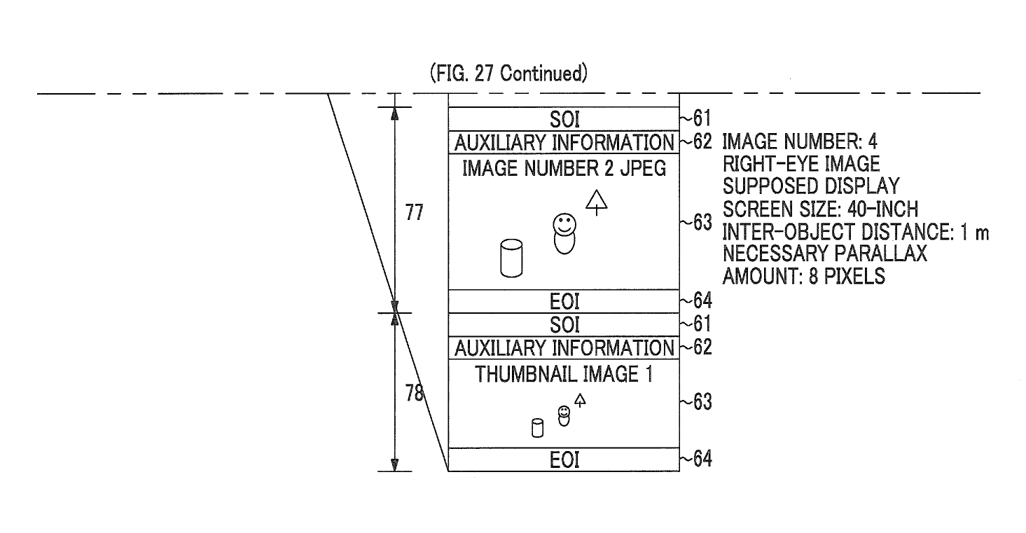

FIG. 27 shows an example of the file structure of a file which stores image data representing each of the left-eye image and the right-eye image obtained in the above-described example.

Since FIG. 27 corresponds to FIG. 21, the same things as those shown in FIG. 21 are represented by the same reference numerals, and description thereof will not be repeated.

Image data representing the left-eye image is stored in the image data recording region 63 of the first recording region 71. Image data representing the thumbnail image of the left-eye image is stored in the image data recording region 63 of the second recording region 72.

As described above, image data which represents the right-eye image having the necessary parallax amount corresponding to the inter-object distance and the display screen size is recorded in the third recording region 73, the fifth recording region 75, and the seventh recording region 77. Thumbnail image data is recorded in the fourth recording region 74, the sixth recording region 76, and the eighth recording region 78.

In this way, image data which represents the left-eye image and the right-eye images for a plurality of frames is stored in a single file, and the file is recorded in the memory card.

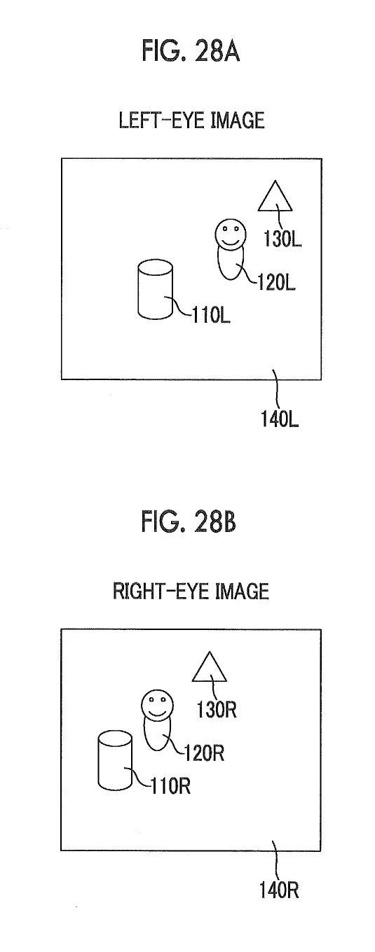

FIG. 28A shows an example of the left-eye image recorded in this example, and FIG. 28B shows an example of the right-eye image recorded in this example.

Referring to FIG. 28A, a left-eye image 140L includes a first object image 110L representing the first object OB10, a second object image 120L representing the second object OB20, and a third object image 130L representing the third object OB30.

Referring to FIG. 28B, a right-eye image 140R includes a first object image 110R representing the first object OB10, a second object image 120R representing the second object OB20, and a third object image 130R representing the third object OB30.

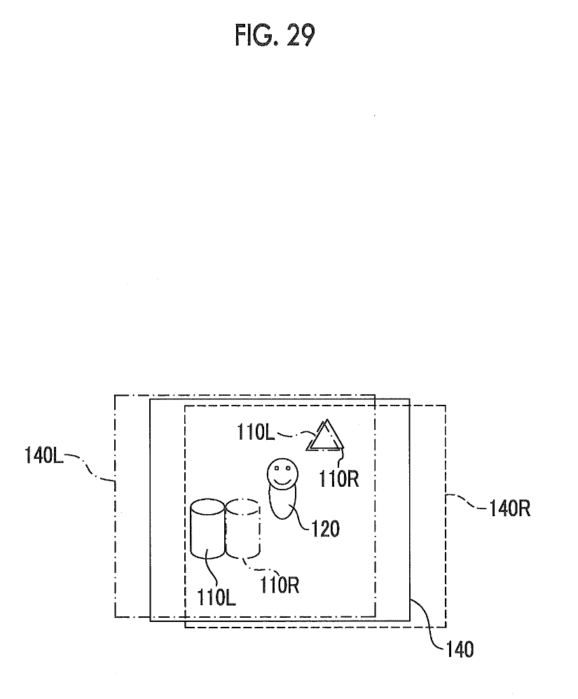

FIG. 29 shows a stereoscopic image 140 in which the left-eye image 140L shown in FIG. 28A and the right-eye image 140R shown in FIG. 28B are superimposed.

The left-eye image 30L and the right-eye image 30R are superimposed such that the left-eye image 140L shown in FIG. 28A and the right-eye image 140R shown in FIG. 28B are deviated from each other in the horizontal direction by the necessary parallax amount. When this happens, the second subject image 120 representing the second object OB20 as a principal subject has no horizontal deviation. Meanwhile, there is horizontal deviation between the first object images 110L and 11OR representing the first object OB10. Similarly, there is horizontal deviation between the first object images 130L and 130R representing the third object OB30. From the occurrence of horizontal deviation, the user can view the stereoscopic image.

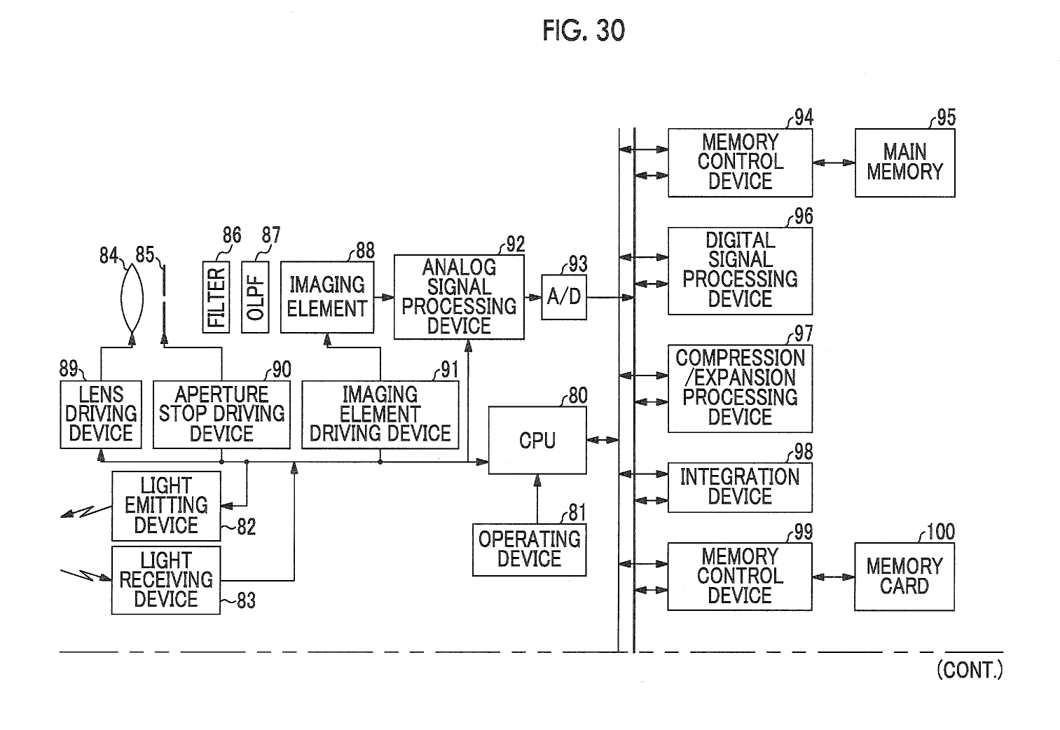

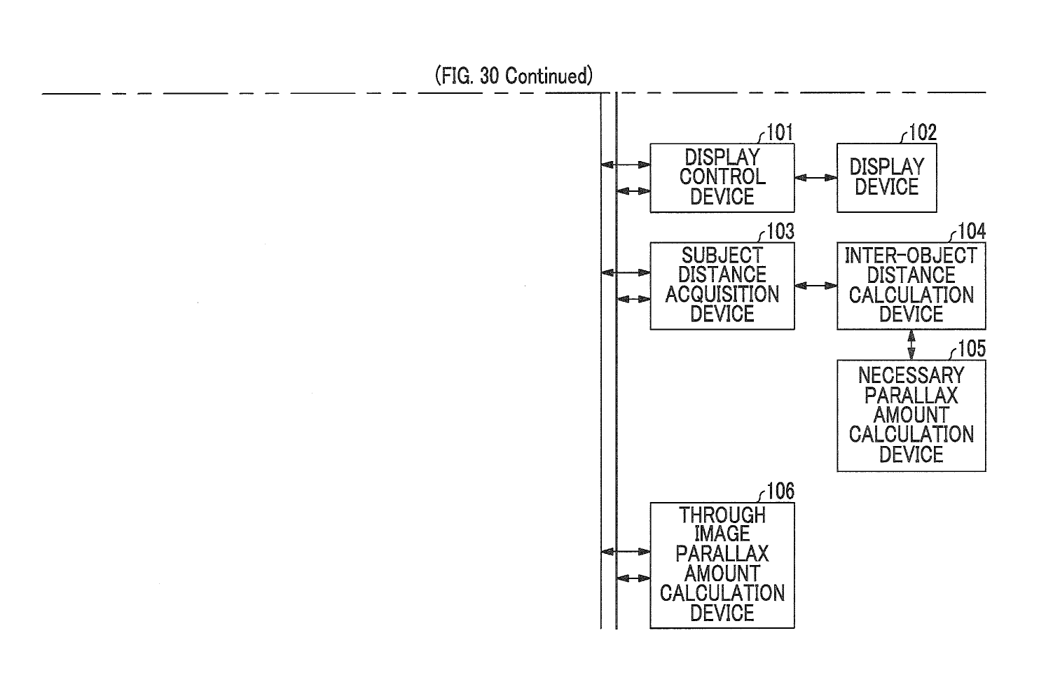

FIG. 30 is a block diagram showing the electrical configuration of the digital still camera of this example. Since FIG. 30 corresponds to the block diagram shown in FIG. 22, the same things as those shown in FIG. 22 are represented by the same reference numerals, and description thereof will not be repeated.

The digital still camera shown in FIG. 30 is provided with an inter-object distance calculation device 104A. As described above, in the subject distance acquisition device 103, the distances to each of a plurality of objects are calculated. Data representing the calculated distance to each of a plurality of objects is input from the subject distance acquisition device 103 to the inter-object distance calculation device 104. In the inter-object distance calculation device 104, the inter-object distance is calculated from input data. As described above, the necessary parallax amount is decided based on the inter-object distance. As described above, a subject image which has the decided necessary parallax amount is recorded in the memory card 100.

If the stereoscopic reproduction mode is set, as described above, image data which represents each of the left-eye image and the right-eye image recorded in the memory card 100 and corresponds to the size of the display screen of the display device 102 is read. Read image data is given to the display control device 101, such that the stereoscopic image is displayed on the display screen of the display device 102.

In the second example, as in the above-described first example, a parallax amount may be decided based on the size of the display screen on which a stereoscopic image is displayed and the distance information between the closest object and the farthest object. As shown in FIG. 2, the size of the display screen may be set, and the parallax amount may be decided based on the set size of the display screen and the distance information between the closest object and the farthest object. Image data representing the first subject image and the second subject image recorded in the memory card 100 may be read, and the first subject image and the second subject image represented by read image data may be displayed on the display screen of the display device so as to be deviated from each other in the horizontal direction by the decided parallax amount.

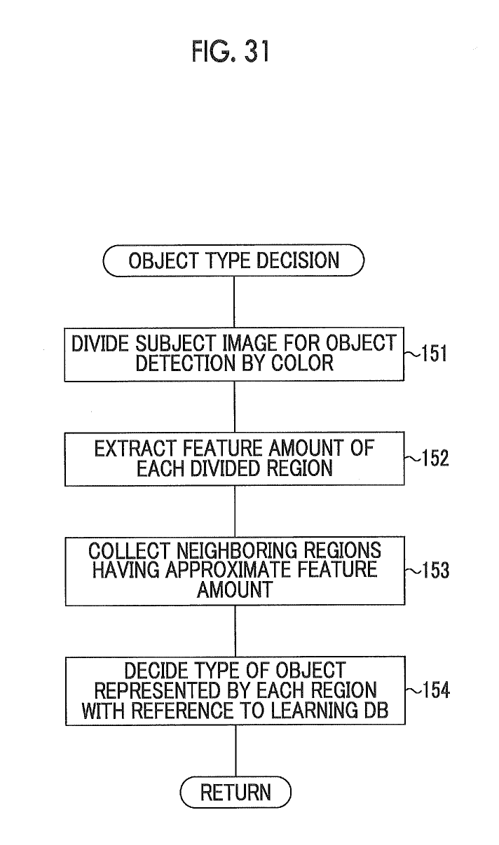

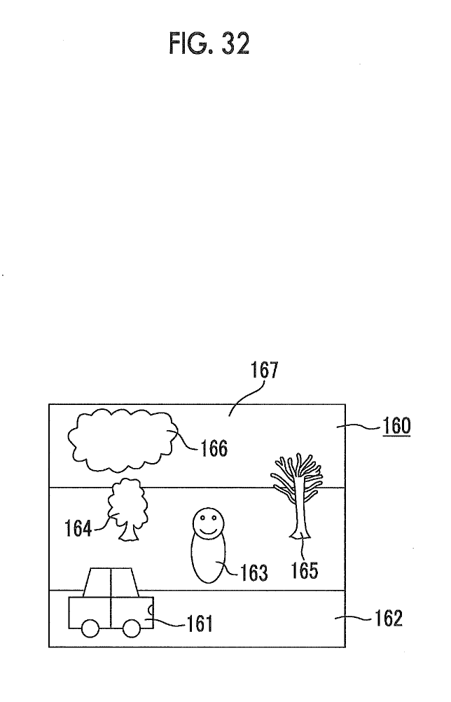

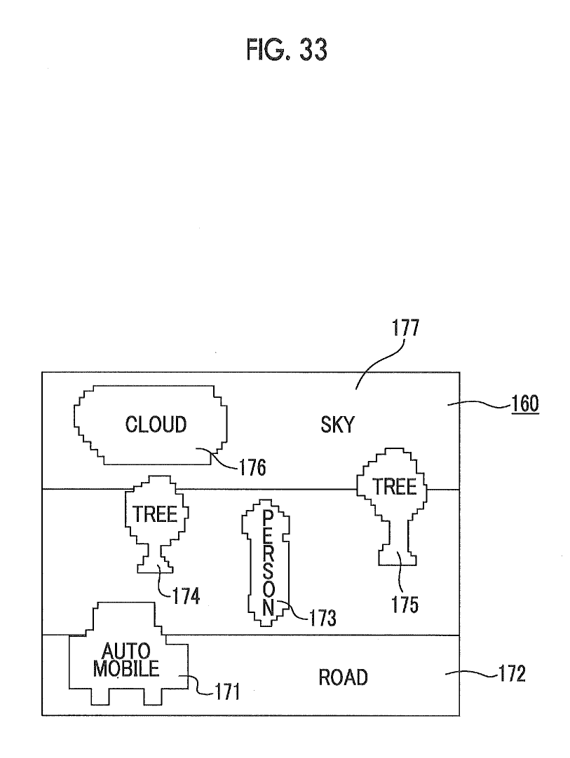

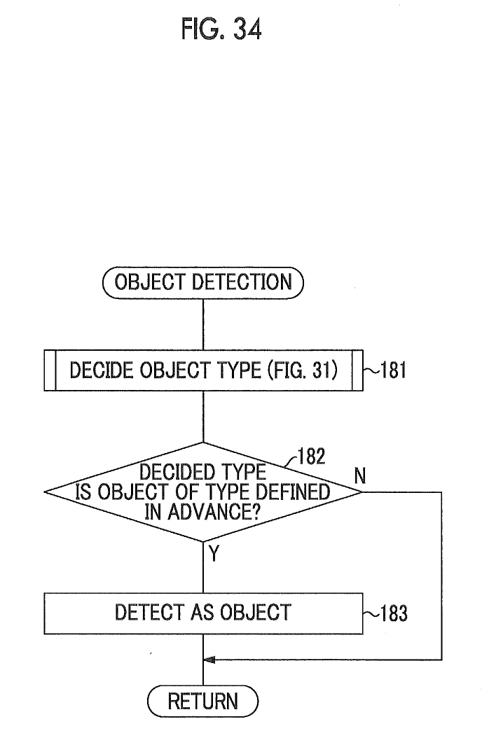

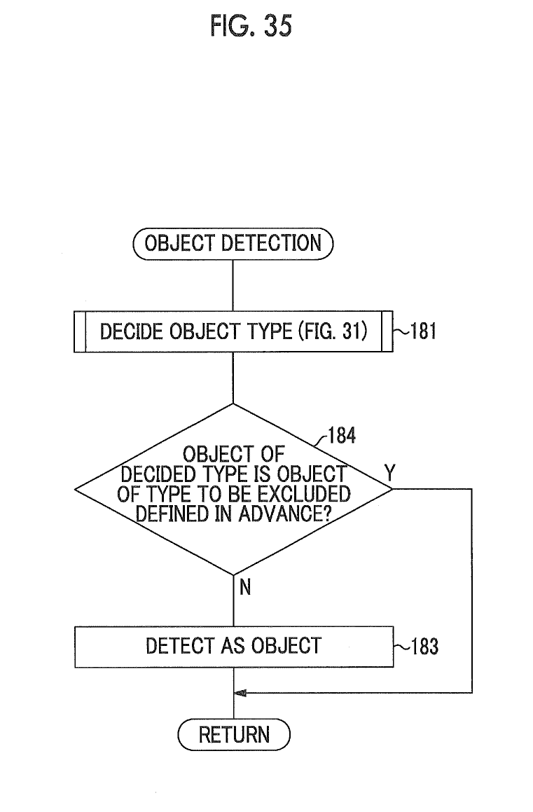

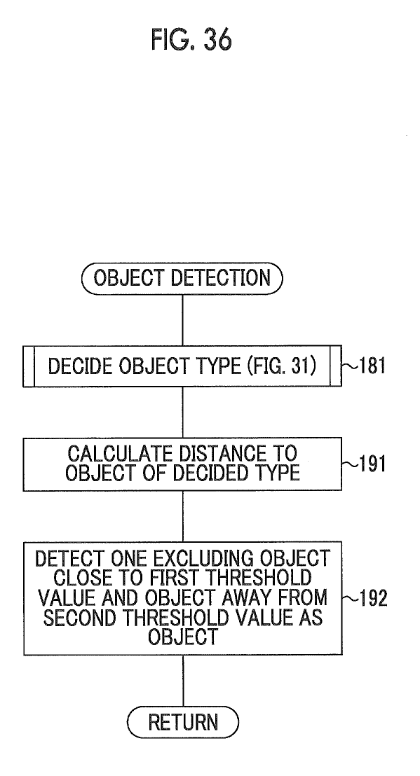

FIGS. 31 to 40 show modifications, and show processing (processing corresponding to Step 29 in FIG. 26) for detecting objects from which the closest object and the farthest object are selected as described above. The closest object and the farthest object described above are decided from among the objects detected through the processing.

FIG. 31 is a flowchart showing a processing procedure in which the types of objects are decided.

As described above, if the shutter release button is half-pressed, a subject is imaged, and image data representing a subject image (subject image for object detection) is obtained.

FIG. 32 shows an example of an image 160 for object detection obtained through imaging. Although the subject is different from FIG. 23, the subject may be of course the same as shown in FIG. 23.

In the image 160 for object detection, a road image 162 is in front, and an automobile image 161 is on the road image 162. A character image 163 is substantially at the center, and tree images 164 and 165 are on the left and right side of the character image 163. A cloud image 166 is on the upper left side of the image 160 for object detection. An upper portion in the image 160 for object detection is a sky image 167.

Referring to FIG. 31, if the subject image 160 for object detection is obtained, the color of each pixel forming the subject image 160 for object detection is detected, and the subject image 160 for object detection is divided into regions for the respective colors (Step 151). It is not necessary to divide the subject image 160 for object detection into regions for the respective colors of full color, and it should suffice that colors (for example, about 32 colors or 64 colors) are used such that the subject image 160 for object detection are divided into regions which are regarded as representing the same objects. Then, the feature amount of each region is extracted from the regions divided for the respective colors (Step 152). The feature amount is defined in advance, and is the color, contrast, or brightness of a divided region, the position of a divided region in the subject image 160 for object detection, or the like. When the regions are divided in this way, since the same objects are represented in different regions, neighboring regions having an approximate feature amount are grouped into one region (Step 153).

If the subject image 160 for object detection is divided into a plurality of regions, the type of object which is represented by each divided region is decided with reference to a learning database (Step 154). The learning database stores the feature amount, such as the color, contrast, or brightness of an object, or the position when imaging, and the type of object in association with each other, and is stored in advance in the main memory 95 as described above. From the feature amount of each divided region, the type of object which is represented by the region can be decided.

FIG. 33 shows the decided types of objects.

As described above, the subject image 160 for object detection is divided into a plurality of regions 171 to 177. The region 171 represents an automobile as the type of object. Similarly, the region 172 represents a road, the region 173 represents a person, the regions 174 and 175 represents trees, the region 176 represents a cloud, and the region 177 represents a sky as the types of objects.

FIG. 34 is a flowchart showing processing (processing corresponding to Step 29 in FIG. 26) for detecting objects from which the closest object and the farthest object are selected using the types of objects decided in the above-described manner.

If the type of object is decided as described above (Step 181), it is determined whether or not the decided type of object corresponds to an object of a type defined in advance (Step 182). If the decided type of object corresponds to an object of a type defined in advance (YES in Step 182), the corresponding object is detected as an object. The closest object and the farthest object are decided from among the detected objects as described above, and the inter-object distance between the closest object and the farthest object is obtained as described above.

When deciding the parallax amount based on the inter-object distance between the closest object and the farthest object, there are objects which will be viewed stereoscopically and objects which will not be viewed stereoscopically. For example, objects which will be viewed stereoscopically are characters, automobiles, trees, buildings, and the like, and objects which will not be viewed stereoscopically are sky, roads, sea, and the like. An object which will be viewed stereoscopically or will not be viewed stereoscopically can be freely decided. For example, it may be presumed that sky, roads, sea, and the like will be viewed stereoscopically, and characters, automobiles, trees, buildings, and the like will not be viewed stereoscopically.

In this example, the type (for example, character, automobile, tree, building) of object which will be viewed stereoscopically is defined in advance, and it is determined whether or not the decided type corresponds to an object which will be viewed stereoscopically. It is possible to prevent the calculation of the inter-object distance between the closest object and the farthest object from the objects which will not be viewed stereoscopically. That is, it is possible to prevent the decision of the parallax amount such that an object which will not be viewed stereoscopically is viewed more stereoscopically.

FIG. 35 is another flowchart showing an object detection processing procedure.

In the processing procedure shown in FIG. 34, an object of a type defined in advance is detected as an object. Meanwhile, in the processing procedure shown in FIG. 35, objects of types to be excluded are defined in advance, and objects which do not correspond to the object types to be excluded are detected as objects.

The type of object is decided as described above (Step 181). When this happens, it is determined whether or not the object of the decided type is an object (for example, road, sky, cloud, sea, or the like) of a type to be excluded defined in advance (Step 184). If the object of the decided type is not an object to be excluded (NO in Step 184), the object of the decided type is detected as an object (Step 183). If the object of the decided type is an object to be excluded (YES in Step 184), the object of the decided type is not detected as an object.

FIG. 36 is another flowchart showing an object detection processing procedure. In the processing procedure, an object closer than a first threshold value and an object farther than a second threshold value are excluded from objects, and the remaining objects are detected as objects.

As described above, if the types of objects are decided (Step 181), the distance to each of the objects of the decided types is calculated (Step 191). As described above, the distance to the object can be calculated by extracting a high-frequency component from image data obtained by imaging the subject while moving the focus lens 84 (AF evaluation value), and using a graph showing the relationship between the AF evaluation value and the lens position of the focus lens 84. As shown in FIG. 33, if regions are divided, a high-frequency component is extracted from image data corresponding to each region to obtain an AF evaluation value, and the distance to an object represented by the region is known from the lens position of the focus lens 84 which gives the maximum AF evaluation value in a graph showing the obtained AF evaluation value and the lens position of the focus lens 84.

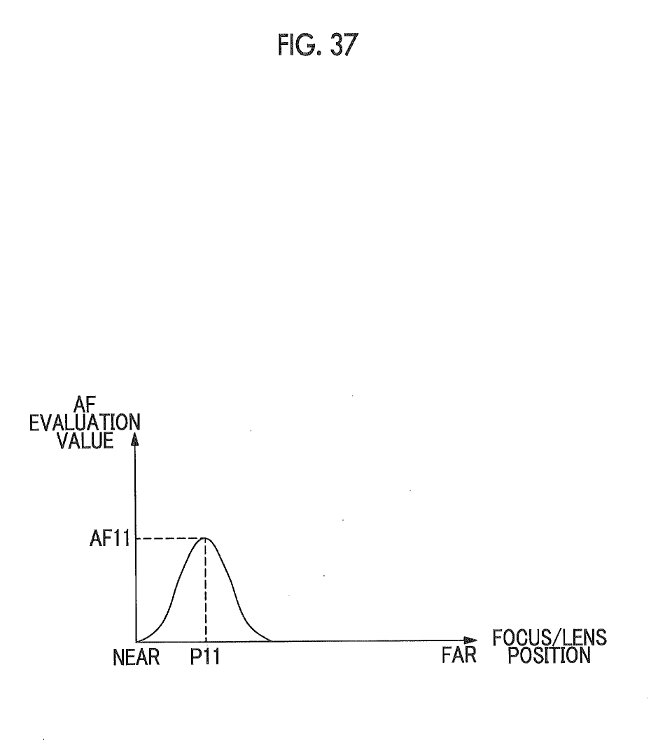

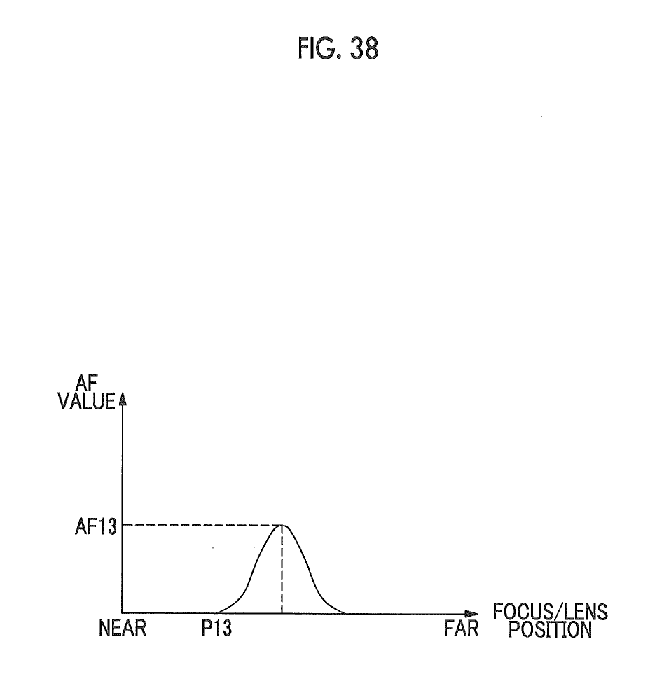

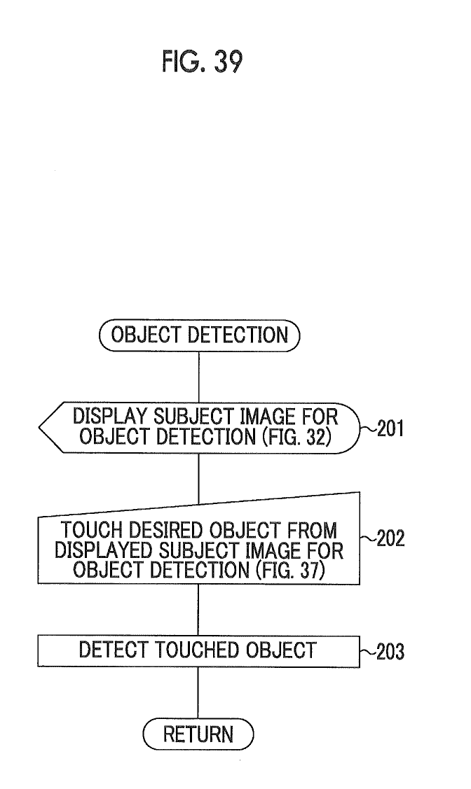

FIG. 37 shows the relationship between the AF evaluation value which is obtained from the region 171 of the image representing an automobile shown in FIG. 33 and the lens position of the focus lens 84.

In FIG. 37, the peak value of the AF evaluation value is AF11, and the lens position of the focus lens 84 at the peak value AF11 is P11. The distance to the automobile is known from how much the lens position P11 is far from the home position of the focus lens 84.

FIG. 38 shows the relationship between the AF evaluation value which is obtained from the region 173 of the image representing a character shown in FIG. 33 and the lens position of the focus lens 84.

In FIG. 38, the peak value of the AF evaluation value is AF13, and the lens position of the focus lens 84 at the peak value AF13 is P13. The distance to the character is known from how much the lens position P13 is far from the home position of the focus lens 84.

As described above, the present invention is not limited to the distance to the automobile or the character, and the distance to a different object may be calculated in the same manner.

Returning to FIG. 36, if the distance to each object is calculated, objects excluding an object closer to a first threshold value (for example, 0.5 m) and an object farther than a second threshold value (for example, 30 m) among the objects with the calculated distance are detected as objects (Step 192). The closest object and the farthest object from among the detected objects are found as described above.

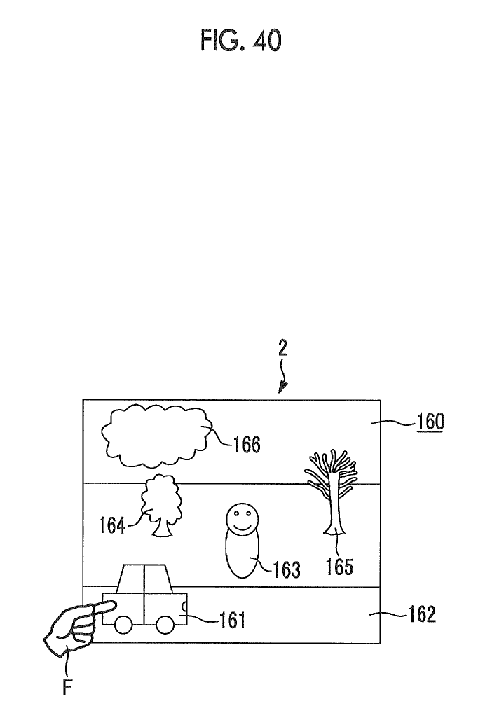

FIGS. 39 and 40 show object detection, and specifically, FIG. 39 is a flowchart showing the processing procedure, and FIG. 40 shows the subject image 160 for object detection which is displayed on the display screen 2.

As described above, if the subject image 160 for object detection is obtained through imaging, the subject image 160 for object detection is displayed on the display screen 2 (Step 201). A touch panel is formed in the surface of the display screen 2, and a desired object from the displayed subject image 160 for object detection is touched by the user (Step 202).

Referring to FIG. 40, the subject image 160 for object detection is displayed on the display screen 2. As described above, the subject image 160 for object detection includes an automobile image 161, a road image 162, a character image 163, tree images 164 and 165, and a cloud image 166, and a sky image 167. The user touches an image portion of a desired object among these images with the finger F. For example, the automobile image 161, the character image 163, and the tree images 164 and 165 are touched with the finger F. An object representing a touched image portion is detected (in FIG. 39, Step 203). The closest object and the farthest object among the touched objects are found.

As described above, the type of the object decided in the object decision processing may be displaced near the corresponding object of the subject image 160 for object detection as shown in FIG. 40. An object which is touched by the user touches is recognized at first glance. As shown in FIG. 33, regions may be divided by object, and the objects whose types are detected in these regions may be displayed on the display screen 2. In this case, an object which is touched by the user is recognized at first glance.

What is claimed is:

1. An imaging apparatus comprising:
an imaging unit which continuously images a subject in an imaging range and continuously outputs imaged image data;
a first recording control unit which, if a recording instruction is given, records image data imaged at the timing, at which the recording instruction is given, in a recording medium as image data representing a first subject image;
an object detection unit which detects all objects satisfying a predetermined condition from subject images for object detection among subject images represented by image data continuously output from the imaging unit;
a first distance information calculation unit which calculates distance information between an object closest to the imaging apparatus and an object farthest from the object detection unit among a plurality of objects;
a parallax amount decision unit which decides a parallax amount based on the distance information calculated by the first distance information calculation unit; and
a second recording control unit which, when the imaging apparatus is deviated in a horizontal direction to make the amount of deviation between a subject image represented by image data continuously output from the imaging unit and the first subject image in the horizontal direction equal to the parallax amount decided by the parallax amount decision unit, records image data imaged at this timing as image data representing a second subject image in the recording medium in association with image data representing the first subject image.

2. The imaging apparatus according to claim 1, further comprising:
a second distance information calculation unit which measures distance information from the imaging apparatus to each of a plurality of objects in the imaging range,
wherein the first distance information calculation unit calculates the distance information between the closest object and the farthest object from the distance information to the closest object and the distance information to the farthest object calculated by the second distance information calculation unit.

3. The imaging apparatus according to claim 2,
wherein the imaging unit includes an imaging element and a focus lens,
the imaging apparatus further comprises:
an AF evaluation value calculation unit which calculates an AF evaluation value representing the degree of focusing at each movement position from image data imaged at each movement position while moving the focus lens, and
the second distance information calculation unit measures the distance to each of the plurality of objects based on the position of the focus lens when the AF evaluation value calculated by the AF evaluation value calculation unit becomes equal to or greater than a threshold value.

4. The imaging apparatus according to claim 1,
wherein the parallax amount decision unit decides the parallax amount defined in advance when the second distance information calculation unit is able to measure only the distance to one object among a plurality of objects detected by the object detection unit.

5. The imaging apparatus according to claim 2,
wherein the parallax amount decision unit decides the parallax amount defined in advance when the second distance information calculation unit is able to measure only the distance to one object among a plurality of objects detected by the object detection unit.

6. The imaging apparatus according to claim 3,
wherein the parallax amount decision unit decides the parallax amount defined in advance when the second distance information calculation unit is able to measure only the distance to one object among a plurality of objects detected by the object detection unit.

7. The imaging apparatus according to claim 1,
wherein the parallax amount decision unit decides the parallax amount based on the size of a display screen on which a stereoscopic image is displayed and the distance information calculated by the first distance information calculation unit.

8. The imaging apparatus according to claim 2,
wherein the parallax amount decision unit decides the parallax amount based on the size of a display screen on which a stereoscopic image is displayed and the distance information calculated by the first distance information calculation unit.

9. The imaging apparatus according to claim 3,
wherein the parallax amount decision unit decides the parallax amount based on the size of a display screen on which a stereoscopic image is displayed and the distance information calculated by the first distance information calculation unit.

10. The imaging apparatus according to claim 4,
wherein the parallax amount decision unit decides the parallax amount based on the size of a display screen on which a stereoscopic image is displayed and the distance information calculated by the first distance information calculation unit.

11. The imaging apparatus according to claim 5,
wherein the parallax amount decision unit decides the parallax amount based on the size of a display screen on which a stereoscopic image is displayed and the distance information calculated by the first distance information calculation unit.

12. The imaging apparatus according to claim 6,
wherein the parallax amount decision unit decides the parallax amount based on the size of a display screen on which a stereoscopic image is displayed and the distance information calculated by the first distance information calculation unit.

13. The imaging apparatus according to claim 1,
a setting unit which sets the size of a display screen on which a stereoscopic image is displayed,
wherein the parallax amount decision unit decides the parallax amount based on the size of the display screen set by the setting unit and the distance information calculated by the first distance information calculation unit, and
the second recording control unit repeats processing for, when the imaging apparatus is deviated in the horizontal direction to make the amount of deviation between the subject image represented by image data continuously output from the imaging unit and the first subject image in the horizontal direction equal to any parallax amount of a plurality of parallax amounts decided by the parallax amount decision unit, recording image data imaged at this timing as image data representing the second subject image in the recording medium in association with image data representing the first subject image for the plurality of parallax amounts.

14. The imaging apparatus according to claim 1, further comprising:
a reading unit which reads image data representing the first subject image stored in the recording medium and image data representing the second subject image recorded in the recording medium from the recording medium in response to a stereoscopic reproduction instruction; and
a display control unit which performs control such that a display device displays a first subject image represented by image data representing the first subject image and a second subject image represented by image data representing the second subject image read by the reading unit with deviation in the horizontal direction by the parallax amount decided by the parallax amount decision unit.

15. The imaging apparatus according to claim 1, further comprising:
an object type decision unit which decides the type of an object in the subject images for object detection,
wherein the object type decision unit detects an object of a type defined in advance among the types of objects decided by the object type decision unit.

16. The imaging apparatus according to claim 1, further comprising:
an object type decision unit which decides the type of an object in the subject images for object detection,
wherein the object detection unit detects an object of a type excluding a type defined in advance among the types of objects decided by the object type decision unit.

17. The imaging apparatus according to claim 15, further comprising:
a distance calculation unit which calculates the distance to an object whose type is decided by the object decision unit,
wherein the object detection unit detects an object excluding an object, whose distance calculated by the distance calculation unit is equal to or smaller than a first threshold value, and an object, whose distance is equal to or greater than a second threshold value greater than the first threshold value, among the objects of the types decided by the object type decision unit.

18. The imaging apparatus according to claim 1, further comprising:
a display device which displays the first subject image on a display screen; and
a touch panel which is formed in the display screen,
wherein the object detection unit detects an object displayed at a position where the touch panel is touched.

19. A movement controlling method for an imaging apparatus,
wherein, using the imaging apparatus according to claim 1,
an imaging unit continuously images a subject in an imaging range and continuously outputs imaged image data,
if a recording instruction is given, a first recording control unit records image data imaged at the timing, at which the recording instruction is given, in a recording medium as image data representing a first subject image,
an object detection unit detects all objects satisfying a predetermined condition from subject images for object detection among subject images represented by image data continuously output from the imaging unit,
a first distance information calculation unit calculates distance information between an object closest to the imaging apparatus and an object farthest from the object detection unit among a plurality of objects,
a parallax amount decision unit decides a parallax amount based on the distance information calculated by the first distance information calculation unit, and
when the imaging apparatus is deviated in a horizontal direction to make the amount of deviation between a subject image represented by image data continuously output from the imaging unit and the first subject image in the horizontal direction equal to the parallax amount decided by the parallax amount decision unit, a second recording control unit records image data imaged at this timing as image data representing a second subject image in the recording medium in association with image data representing the first subject image.
